(19) United States
(12) Patent Application Publication
(10) Pub. No.: US 2016/0070828 A1
(43) Pub. Date: Mar. 10, 2016

(54) Vulnerability Assessment Method of Water Inrush from Aquifer Underlying Coal Seam

(71) Applicant: China University of Mining & Technology, Beijng, Beijing (CN)

(72) Inventor: Qiang Wu, (US)

(21) Appl. No.: 14/387,056

(22) PCT Filed: Nov. 7, 2013
(86) PCT No.: PCT/CN2013/086689

§ 371 Date: Sep. 22, 2014

(30) Foreign Application Priority Data
Apr. 8, 2013 (CN) 20130119817.6

(51) Int. Cl. G06F 17/50; G06F 17/10; E21F 17/00

(52) U.S. Cl. CPC G06F 17/5009; E21F 17/00; G06F 17/10

(57) ABSTRACT

A vulnerability assessment method of water inrush from an aquifer underlying coal seam includes steps of: collecting main control factors determined by geological data of a target area to be assessed; quantifying relevant data against the main control factors to form thematic maps; performing normalization processing against attribute data corresponding to the respective thematic maps; establishing databases of normalized attribute data corresponding to the normalized thematic maps by utilizing GIS; determining a weight of each main control factor based on a constant weight model; determining a variable weight of each main control factor based on a zonation variable weight model; performing composite superimposition on the normalized thematic maps of the respective single main control factors, and newly building a topological relation of the relevant data among the attribute databases for performing multi-factor fitting analysis; and establishing a vulnerability assessment model based on the zonation variable weight model.

### CROSS REFERENCE OF RELATED APPLICATION

This is a U.S. National Stage under 35 U.S.C. 371 of the International Application PCT/CN2013/086689, filed Nov. 7, 2013, which claims priority under 35 U.S.C. 119(a-d) to CN 201310119817.6, filed Apr. 8, 2013.

### BACKGROUND OF THE PRESENT INVENTION

1. Field of Invention

The present invention relates to a characteristic parameter assessment method of a physical structure, and more particularly to a vulnerability assessment method of the physical structure.

2. Description of Related Arts

Mine water disasters have been one of the important factors restricting the production and the development of coal in China. The coal reserves threatened by water disasters account for approximately 27% of the proved reserves. At present, many mines have entered the deep mining, and the mining elevations of lower coal groups of some mines have achieved −600 to −1000 m. The water pressure of karst confined water born by an overlying coal seam has achieved 2.0-6.5 MPa; the typical thickness of an aquifuge between the lower coal group and an underlying limestone karst aquifer is only 10-20 m with the maximum value of only 50-60 m; and the aquifuge extends to the deep part along with the mine. The water pressure of the underlying aquifer exerted on a working face increases gradually. As a result, the risk of water inrush increases continuously.

In China, an experience water inrush coefficient assessment method for predicting underlied water inrush has been summed up according to actual data of underlied water inrush in various mines when a mining area was mined to a certain depth, and the method has been used till now.

However, there are many reasons causing the water inrush from the aquifer underlying coal seam, and the process shows a very complex non-liner dynamic characteristic. The conventional water inrush coefficient method is (1) very limited in the consideration of factors influencing water inrush (2) cannot describe the non-liner power phenomenon of the water inrush from the aquifer underlying coal seam, which is controlled by multiple factors and has a very complex mechanism, and (3) has not been suitable for new mining methods and new assessment methods of water inrush from the aquifer underlied coal seam under hydrogeological environmental conditions.

Based on the above reasons, Professor Wu Qiang in China University of Mining Technology (Beijing) has been committed to researching multi-source information-based integration theory and “loop overlapping theory” since the late 1990s. He studied the water inrush from the aquifer underlying coal seam by adopting an integration technology of a geographic information system (GIS) with strong spatial data statistical analysis and processing function and a linear or non-linear mathematical method and proposed a GIS-based information fusion type vulnerability index assessment method. The method can truly reflect the water inrush from the aquifer underlying coal seam which is controlled by multiple factors and has very complex mechanism and evolution process, and better solve the difficult problem of forecasting and predicting the water inrush from the aquifer underlying coal seam.

However, determination of the weight of each main control factor adopts an information fusion method. Once the weight is determined, no matter how the index value of the main control factor changes in an investigation area and no matter how big the amplitude of the sudden change situation is, the weight value is fixed in the entire investigation time period. A constant weight model with the fixed weight only considers the relative importance of each index in decision-making and ignores the preference to the state equilibrium degree. The control and influencing characteristic of each single main control factor against the water inrush from the aquifer underlying coal seam due to sudden changes of the index value caused by changes in hydrogeological conditions in the investigation area cannot be illustrated. Therefore, the “incentive” and the “penalty” mechanisms of each main control factor for control and influence against the water inrush from the aquifer underlying coal seam due to sudden changes of the index value in the investigation area cannot be disclosed. The relative importance and the preference of each main control factor, as well as the control and the influencing effects of each main control factor against the water inrush from the aquifer underlying coal seam in a multi-combination changing state of the multiple main control factors cannot be reflected.

### SUMMARY OF THE PRESENT INVENTION

An object of the present invention is to provide a vulnerability assessment method of water inrush from an aquifer underlying coal seam based on a zonation variable weight model. The innovative assessment method is able to solve the following technical problems that are caused with the conventional weight model assessment method:

1) Effective correlation analysis is able to be performed on various main control factors;

2) The inherent changing law of the various main control factors is able to be obtained, and thus the assessment precision is higher.

Accordingly, in order to accomplish the above object, the present invention provides a vulnerability assessment method of water inrush from an aquifer underlying coal seam based on a zonation variable weight model, comprising steps of:

step 1, collecting main control factors of underlying aquifer water inrush, which are determined by geological data of a target area to be assessed;

step 2, quantifying relevant data against the main control factors of the underlying water inrush to form thematic maps for each main control factor;

step 3, performing normalization against attribute data corresponding to the respective main control factor thematic maps to eliminate the influence of scale factors among the attribute data and form normalized thematic maps corresponding to the respective main control factors;

step 4, establishing databases of normalized attribute data corresponding to the normalized thematic maps by utilizing GIS;

step 5, determining a constant weight of each main control factor based on a constant weight model;

step 6, determining a variable weight of each main control factor based on a zonation variable weight model;

step 7, performing composite superimposition on the normalized thematic maps of the respective individual main control factors, and newly building a topological relation of the relevant data among the attribute databases for performing multi-factor fitting analysis; and

step 8, establishing an underlying aquifer water inrush vulnerability assessment model based on the zonation variable weight model to perform vulnerability assessment of the water inrush from the aquifer underlying coal seam.

The main control factors in the step 1 are obtained by collection and processing of basic data of the water-filled aquifer underlying coal seam, basic data of geological structure of the coal seam and basic data of water-impermeable strength of an aquifuge.

The main control factors in the step 2 comprise a plurality of items in an equivalent thickness of an effective aquifuge, a thickness of brittle rock below a zone destroyed by underground mining, distribution of faults and folds, distribution of intersection points and endpoints of the faults and the folds, fault scale indexes, water abundance of an underlying limestone aquifer, water pressure of the underlying limestone aquifer, distribution of karst collapse columns, an equivalent thickness of an Ordovician limestone top ancient weathering crust according to geological conditions.

A normalization formula adopted for eliminating a scale effect on an assessment result in the step 3 is as follows:

$${A}_{i} = a + \frac{( b - a ) \times ( {x}_{i} - min ( {x}_{i} ) )}{max ( {x}_{i} ) - min ( {x}_{i} )} \qquad ( 3 \text{-} 4 )$$

wherein Aᵢ is the data after normalization processing, a and b are a lower limit and an upper limit of a normalization range respectively, 0 and 1 are taken in this research, and min(xᵢ) and max(xᵢ) are a minimum value and a maximum value of quantified values of each main control factor.

A weight value of each control factor is determined by establishing a hierarchy analysis model, constructing a judgment matrix and performing hierarchical sorting and consistency testing in the step 5.

The zonation variable weight model utilized for determining the variable weight of each main control factor in the step 6 is as follows:

$$\begin{matrix}W ( X ) {=}^{Δ} \frac{{W}_{0} • S ( X )}{{\sum }_{j = 1}^{m} {w}_{j}^{( 0 )} {S}_{j} ( X )} {=}^{Δ} ( \frac{{w}_{1}^{( 0 )} {S}_{1} ( X )}{{\sum }_{j = 1}^{m} {w}_{j}^{( 0 )} {S}_{j} ( X )} , \frac{{w}_{2}^{0} {S}_{2} ( X )}{{\sum }_{j = 1}^{m} {w}_{j}^{0} {S}_{j} ( X )} , … , \frac{{w}_{m}^{0} {S}_{m} ( X )}{{\sum }_{j = 1}^{m} {w}_{j}^{0} {S}_{j} ( X )} ) & ( 3 \text{-} 6 ) \\ wherein & \\ {S}_{j} ( x ) = \{ \begin{matrix}{e}^{{a}_{1} ( {d}_{1} - x )} + c - 1 , & x ∈ [ 0 , {d}_{1} ) \\ c , & x ∈ [ {d}_{1} , {d}_{2} ) \\ {e}^{{a}_{2} ( x - {d}_{2} )} + c - 1 , & x ∈ [ {d}_{2} , {d}_{3} ) \\ {e}^{{a}_{3} ( x - {d}_{3} )} + {e}^{{a}_{2} ( {d}_{3} - {d}_{2} )} + c - 2 , & x ∈ [ {d}_{3} , 1 ]\end{matrix} & ( 3 \text{-} 7 )\end{matrix}$$

S(X): an m-dimensional zone state variable weight vector; W₀=(w₁⁽⁰⁾, w₂⁽⁰⁾, . . . , wₘ⁽⁰⁾): any constant weight vector; W(X): an m-dimensional zone state variable weight vector; c: a regulation level; a₁, a₂ and a₃: parameters to be determined; and d₁, d₂ and d₃: thresholds of variable weight intervals.

A formula of the underlying water inrush vulnerability assessment model in the step 8 is represented as follows:

$$VI = {\sum }_{i = 1}^{m} {w}_{i} • {f}_{i} ( x , y ) = {\sum }_{i = 1}^{m} \frac{{w}_{i}^{( 0 )} {S}_{i} ( X )}{{\sum }_{j = 1}^{m} {w}_{j}^{( 0 )} {S}_{j} ( X )} {f}_{i} ( x , y ) = \frac{{w}_{1}^{( 0 )} {S}_{1} ( X )}{{\sum }_{j = 1}^{7} {w}_{j}^{( 0 )} {S}_{j} ( X )} {f}_{1} ( x , y ) + \frac{{w}_{2}^{( 0 )} {S}_{2} ( X )}{{\sum }_{j = 1}^{7} {w}_{j}^{( 0 )} {S}_{j} ( X )} {f}_{2} ( x , y ) + \frac{{w}_{3}^{( 0 )} {S}_{3} ( X )}{{\sum }_{j = 1}^{7} {w}_{j}^{( 0 )} {S}_{j} ( X )} {f}_{3} ( x , y ) + \frac{{w}_{3}^{( 0 )} {S}_{3} ( X )}{{\sum }_{j = 1}^{7} {w}_{j}^{( 0 )} {S}_{j} ( X )} {f}_{3} ( x , y ) + \frac{{w}_{4}^{( 0 )} {S}_{4} ( X )}{{\sum }_{j = 1}^{7} {w}_{j}^{( 0 )} {S}_{j} ( X )} {f}_{4} ( x , y ) + \frac{{w}_{5}^{( 0 )} {S}_{5} ( X )}{{\sum }_{j = 1}^{7} {w}_{j}^{( 0 )} {S}_{j} ( X )} {f}_{5} ( x , y ) + \frac{{w}_{6}^{( 0 )} {S}_{6} ( X )}{{\sum }_{j = 1}^{7} {w}_{j}^{( 0 )} {S}_{j} ( X )} {f}_{6} ( x , y ) + \frac{{w}_{7}^{( 0 )} {S}_{7} ( X )}{{\sum }_{j = 1}^{7} {w}_{j}^{( 0 )} {S}_{j} ( X )} {f}_{7} ( x , y ) \qquad ( 3 \text{-} 8 )$$

VI: a vulnerability index; Wᵢ: a variable weight vector of influencing factor; fᵢ(x,y): a function of a single factor-influencing value;

(x,y): geographic coordinates; w⁽⁰⁾: any constant weight vector; and S(X): an m-dimensional zone state variable weight vector.

The thresholds of the variable weight intervals of the zonation variable weight model are determined by a dynamic clustering method.

Preferred values of the regulation level C in the state variable weight vector and the parameters a₁, a₂ and a₃ to be determined in the zonation variable weight model are as follows: C=0.2, a₁=0.15, a₂=0.15 and a₃=0.3.

The vulnerability assessment method of the water inrush from the aquifer underlying coal seam based on the zonation variable weight model is able to solve a key technical problem in vulnerability assessment prediction of the water inrush from the aquifer underlying coal seam by applying the zonation variable weight model to the collected geological data of a stratum to analyzing the data of the underlying coal seam. The variable weight model considers not only relative importance of the weight of each objective main control factor in the water inrush from the aquifer underlying coal seam process, which is able to be reflected by the constant weight model, but also effectively considers a control effect of index state values of each objective main control factor in different units of a research area against the water inrush from the aquifer underlying coal seam, which is not able to be processed by the constant weight model. More importantly, the variable weight model is able to consider the effects of the index state values of a variety of the objective main control factors under a horizontal situation of different combination states, and the effects are realized by continuously adjusting the weights of the objective main control factors in the different units of the research area to change along with changes of the state values. The zonation variable weight model is adopted to process assessment data, and pays attention to not only the control effects of the respective objective main control factors against the water inrush from the aquifer underlying coal seam, but also control effects of mutual correlation among the various objective main control factors against the water inrush from the aquifer underlying coal seam, and further effectively reflects a changing law of the respective objective main control factors in the water inrush from the aquifer underlying coal seam problem. Therefore, the assessment result is more reasonable; the assessment method is more advanced; and the assessment result is more in line with actual production. By using the method, a defect of having only one constant weight in the entire investigation area of each objective main control factor in the assessment prediction process is overcome. The vulnerability assessment prediction of the water inrush from the aquifer underlying coal seam is able to be greatly improved.

The embodiments of the invention are further illustrated in combination with the accompanying drawings.

### BRIEF DESCRIPTION OF THE DRAWINGS

FIG. 1 is a water pressure thematic map of an underlying limestone aquifer, formed in a vulnerability assessment method of water inrush from an aquifer underlying coal seam based on a zonation variable weight model;

FIG. 2 is a water abundance thematic map of the underlying limestone aquifer, formed in the vulnerability assessment method of the water inrush from the aquifer underlying coal seam based on the zonation variable weight model;

FIG. 3 is an equivalent thickness thematic map of an underlying effective aquifuge, formed in the vulnerability assessment method of the water inrush from the aquifer underlying coal seam based on the zonation variable weight model;

FIG. 4 is a thickness thematic map of a brittle rock below a zone destroyed by underground mining formed in the vulnerability assessment method of the water inrush from the aquifer underlying coal seam based on the zonation variable weight model;

FIG. 5 is a thematic map of distribution of faults and folds, formed in the vulnerability assessment method of the water inrush from the aquifer underlying coal seam based on the zonation variable weight model;

FIG. 6 is a thematic map of intersection points and endpoints of the faults and the folds, formed in the vulnerability assessment method of the water inrush from the aquifer underlying coal seam based on the zonation variable weight model;

FIG. 7 is a thematic map of fault scale index contours, formed in the vulnerability assessment method of the water inrush from the aquifer underlying coal seam based on the zonation variable weight model;

FIG. 8 is a normalized thematic map of an underlying limestone water pressure born by the underlying coal seam aquifuge, formed in the vulnerability assessment method of the water inrush from the aquifer underlying coal seam based on the zonation variable weight model;

FIG. 9 is a water abundance normalized thematic map of the underlying limestone aquifer of a coal seam, formed in the vulnerability assessment method of the water inrush from the aquifer underlying coal seam based on the zonation variable weight model;

FIG. 10 is an equivalent thickness normalized thematic map of an underlying limestone effective aquifuge of the coal seam, formed in the vulnerability assessment method of the water inrush from the aquifer underlying coal seam based on the zonation variable weight model;

FIG. 11 is a thickness normalized thematic map of the brittle rock below the zone destroyed by underground mining of the underlying limestone of the coal seam, formed in the vulnerability assessment method of the water inrush from the aquifer underlying coal seam based on the zonation variable weight model;

FIG. 12 is a normalized thematic map of the distribution of the faults and the folds of the underlying coal seam, formed in the vulnerability assessment method of the water inrush from the aquifer underlying coal seam based on the zonation variable weight model;

FIG. 13 is a normalized thematic map of the distribution of the faults and the folds of the underlying coal seam, formed in the vulnerability assessment method of the water inrush from the aquifer underlying coal seam based on the zonation variable weight model;

FIG. 14 is a normalized thematic map of fault scale indexes of the underlying coal seam, formed in the vulnerability assessment method of the water inrush from the aquifer underlying coal seam based on the zonation variable weight model;

FIG. 15 is a schematic diagram of a vulnerability assessment model of the water inrush from the underlying limestone aquifer of coal seam, utilized in the vulnerability assessment method of the water inrush from the aquifer underlying coal seam based on the zonation variable weight model;

FIG. 16 is a flow diagram of a dynamic clustering method utilized in the vulnerability assessment method of the water inrush from the aquifer underlying coal seam based on the zonation variable weight model;

FIG. 17 is a method flow diagram about a regulation level C and parameters a₁, a₂ and a₃ to be determined, utilized in the vulnerability assessment method of the water inrush from the aquifer underlying coal seam based on the zonation variable weight model;

FIG. 18 is a 5# water inrush from an aquifer underlying coal seam vulnerability assessment zonation map based on the zonation variable weight model, formed in the vulnerability assessment method of the water inrush from the aquifer underlying coal seam based on the zonation variable weight model;

FIG. 19 is a zonation detailed schematic diagram of a water inrush vulnerability assessment zonation map formed in the vulnerability assessment method of the water inrush from the aquifer underlying coal seam based on the zonation variable weight model;

FIG. 20 is a zonation detailed schematic diagram of a water inrush vulnerability assessment zonation map formed by a conventional vulnerability assessment method of water inrush from an aquifer underlying coal seam;

FIG. 21 is a partial enlarged view of an area A variable weight model in the water inrush vulnerability assessment zonation map formed in the vulnerability assessment method of the water inrush from the aquifer underlying coal seam based on the zonation variable weight model;

FIG. 22 is a partial enlarged view of an area A constant weight model in the water inrush vulnerability assessment zonation map formed by the conventional vulnerability assessment method of the water inrush from the aquifer underlying coal seam;

FIG. 23 is a partial enlarged view of an area B variable weight model in the water inrush vulnerability assessment zonation map formed in the vulnerability assessment method of the water inrush from the aquifer underlying coal seam based on the zonation variable weight model;

FIG. 24 is a partial enlarged view of a area B constant weight model in the water inrush vulnerability assessment zonation map formed by the conventional vulnerability assessment method of the water inrush from the aquifer underlying coal seam;

FIG. 25 is a partial enlarged view of an area C variable weight model in the water inrush vulnerability assessment zonation map formed in the vulnerability assessment method of the water inrush from the aquifer underlying coal seam based on the zonation variable weight model;

FIG. 26 is a partial enlarged view of an area C constant weight model in the water inrush vulnerability assessment zonation map formed by the conventional vulnerability assessment method of the water inrush from the aquifer underlying coal seam; and

FIG. 27 is a schematic diagram of a data processing process including collection of basic data, data filtration, data graphication, establishment of a variable weight model and water inrush vulnerability assessment of the conventional vulnerability assessment method of the water inrush from the aquifer underlying coal seam.

### DETAILED DESCRIPTION OF THE PREFERRED EMBODIMENT

According to current serious underlying water inrush problems and relevant data information of a certain mining area, specific steps for vulnerability assessment zonation, forecasting and prediction of risks of water inrush from a #5 underlying coal seam in a mining area (research area) are as follows:

a) Determining main control factors of underlying water inrush in a target area to be assessed.

Determination of the main control factors mainly comprises collection of objective data and data analysis in the following aspects:

basic data of a water-filled aquifer of an underlying coal seam, including water abundance data, water pressure data of the aquifer and the like; basic data of a geological structure of a coal seam, including distribution data and development data of karst collapse columns, folds and faults in a wellfield, scale sizes and other data; and basic data of water-impermeable strength of an aquifuge, including thickness data of the aquifuge between the underlying coal seam and the main aquifer, lithological combination data, data of distribution positions and the like.

According to the collected data, the underlying coal seam is determined to be limestone, and the main control factors influencing limestone underlying water inrush are as follows:

an equivalent thickness of an effective aquifuge;

a thickness of a brittle rock below a zone destroyed by underground mining; distribution of the faults and the folds;

distribution of intersection points and endpoints of the faults and the folds; fault scale indexes;

water abundance of an underlying limestone aquifer;

a water pressure of the underlying limestone aquifer;

distribution of the karst collapse columns; and

an equivalent thickness of an Ordovician limestone top ancient weathering crust.

b) Collecting and quantifying data of the main control factors of the water inrush from the aquifer underlying coal seam, as well as establishing thematic maps thereof.

Original data of the main control factors of the #5 water inrush from the aquifer underlying coal seam in an assessment area is utilized for performing interpolation processing. Attribute databases are further generated, and thematic maps of the respective main control factors are established. The thematic maps are graphical representation forms of corresponding data sets, and establishment of the respective thematic maps and the data of the generated corresponding maps are respectively described as follows:

1) The water pressure of the underlying limestone aquifer

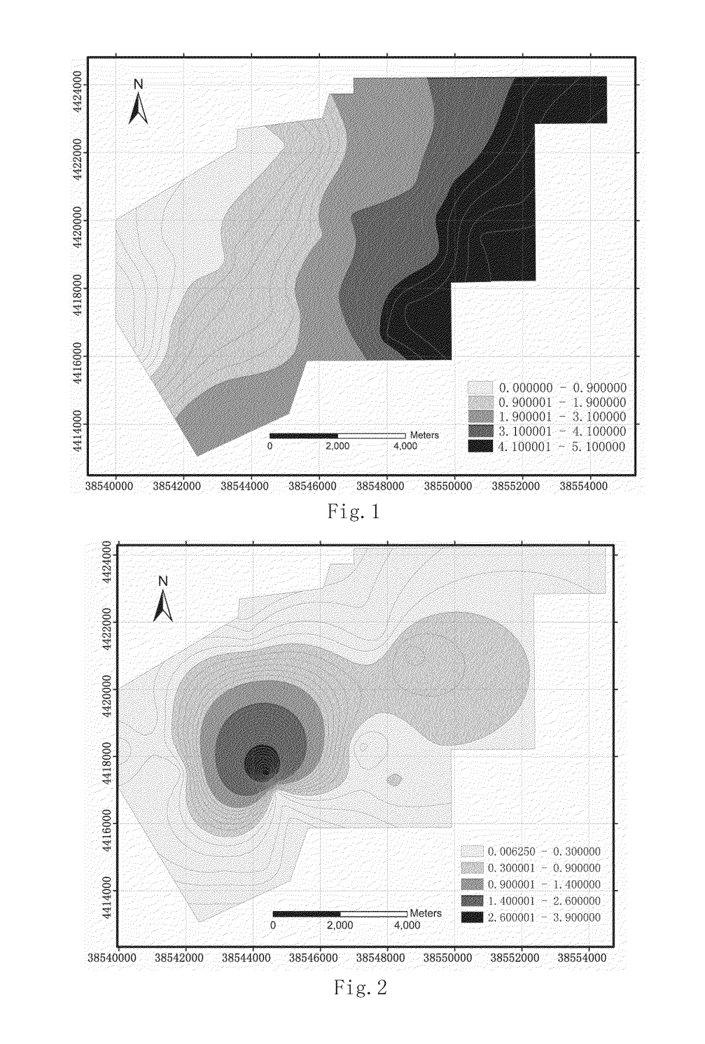

A water level contour map of the underlying limestone aquifer is obtained by interpolation according to borehole data obtained by a coal mine in the research area and water level elevations of all hydrological holes provided by a mining party, as well as regional water situations, then water level values of respective coal-seeing boreholes are calculated according to positions of selected limestone coalfield-seeing holes on the water level contour map, the statistics of underlying elevations of the aquifuge in the various boreholes are further gathered, and the underlying limestone water pressure born by the underlying aquifuge in the research area is further calculated by using the water level elevation of the aquifer to subtract the elevation of the underlying aquifuge of the #5 coal seam. Accordingly, a thematic map of the water pressure of the underlying limestone aquifer, which is born by the #5 underlying coal seam aquifuge in the research area is generated (as shown in FIG. 1). In FIG. 1, a color changing unit is Mpa, and colors from light to dark are represented by values from small to big. Graphic examples of a scale and a north direction are shown in the figure, and numbers of an outer frame represent geographic coordinates.

2) The water abundance of the underlying limestone aquifer

The water abundance of the water-filled aquifer refers to water-containing degree or capability of releasing water of the aquifer. A most ideal index to measure the water abundance of the aquifer is a borehole unit water inflow index. The research totally collects 15 sets of mixed pumping test result data of the underlying limestone aquifer in the assessment area. It is able to be known from the test result data that a unit water inflow of the underlying limestone aquifer in the coal mine is 0.000657-3.86 L/s·m so as to play a certain control effect against the underlying water inrush.

In order to eliminate the influence of calipers and different drawdowns on water inflows, the borehole unit water inflows should be based on the caliber of 91 mm and the pumping drawdown of 10 m, and the conversion formulae are as follows:

$${Q}_{} = {Q}_{} ( \frac{{lgR}_{} - {lgr}_{}}{lg {R}_{} - {lgr}_{}} ) \\ \begin{matrix} & well \\ & hole\end{matrix} \qquad ( 3 \text{-} 1 )$$

R=10S\sqrt{K} (3-2)

In the formulas: Q: water inflow, L/s;

R: influencing radius, m;

r: drilling hole radius, m; and

K: permeability coefficient, m/d.

Through such conversion, the unit water inflows at different calibers and different drawdowns are converted into the unit water inflows at a drilling caliber of 91 mm and a pumping drawdown of 10 m, and then the water abundance of the aquifer is able to be determined in a more standard manner. Statistics and calculation of various pumping test results of the underlying limestone aquifer are respectively gathered and performed according to extracted information to obtain the respective unit water inflows. Accordingly, a water abundance thematic map of the underlying limestone aquifer is formed (as shown in FIG. 2).

3) The equivalent thickness of the effective aquifuge

The thickness of the aquifuge plays a role in inhibiting the water inrush from the aquifer underlying coal seam, and water-impermeable capability of the aquifuge is related to the thickness, the strength and the lithological combinations of the aquifuge. According to a “down three zones” theory of the water inrush from the aquifer underlying coal seam, the effective aquifuge plays a water-impermeable role in a real sense, so that we should firstly determine the thickness of the effective aquifuge and then determine the equivalent thickness of the effective aquifuge.

The thickness of the effective aquifuge equals to a total thickness of the aquifuge minus a depth of the zone destroyed by underground mining and a mine pressure lift height. According to the “down three zones” theory, the underlying coal seam is subject to a action of a mine pressure. Rock stratums are continuously destroyed, and water conductivity changes obviously due to production of cracks. A spatial distribution range of the cracks causing obvious changes in the water conductivity is called an inherent penetration zone. A normal distance from a bottom face of the mined coal seam to a boundary of a deepest part of the distribution range of the water guide cracks is called as “a depth of the inherent penetration zone” and is able to be referred to as “an underlying destroy depth”. The determination methods include a field test observation method, an indoor simulation experimental observation method and an empirical formula method. In this assessment, an empirical formula (3-3) is adopted to calculate the depth of the zone destroyed by underground mining of the 5# underlying coal seam in the assessment area, and the thickness of the effective aquifuge of each borehole is the difference of the total thickness of the aquifuge of the borehole and the depth of the zone destroyed by underground mining.

h=0.0085H+0.1665a+0.1079L−4.3579 (3-3)

In the formula: h: underlying destroy depth, m;

L: slant length of mining working face, m;

H: mining depth, m;

a: inclination angle of mined coal seam, (°).

wherein the slant length of the mining working face is 180 m, the inclination angle of the mined coal seam is 25°, and the mining depth is the depth of the mined underlying coal seam.

An application range of the formula is as follows:

Mining depth: 100-1000 m

Inclination angle: 4°-30°

One-time mining thickness: 0.9-3.5 m (a total thickness of slicing mining is <10 m). As the mine pressure lift height is zero generally, the thickness of the effective aquifuge of each borehole is able to be obtained by subtracting the depth of the zone destroyed by underground mining from the total thickness of the aquifuge.

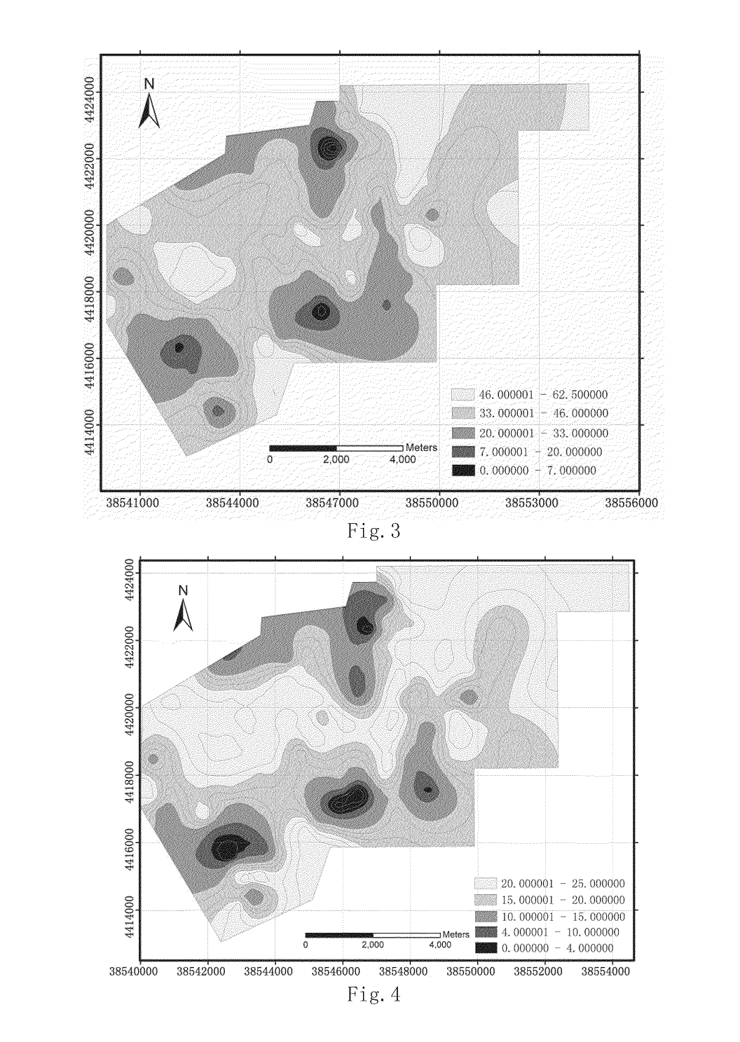

As the aquifuge comprises the rock stratums with a variety of the lithological combinations, influence of different lithological characteristics on the water-impermeable capability must be considered. When in consideration of the water-impermeable strength of different lithologies, according to an equivalent coefficient, thicknesses of the rock stratums with the different lithologies in the effective aquifuge are converted to the corresponding equivalent thicknesses, the equivalent thicknesses are further accumulated to generate the equivalent thickness of the effective aquifuge, and an equivalent thickness thematic map of the underlying effective aquifuge of the #5 coal seam is established according to a final accumulated thickness (as shown in FIG. 3).

4) The thickness of the brittle rock below the zone destroyed by underground mining;

The different lithological combinations and the distribution of positions thereof in the aquifuge greatly affect the underlying water inrush. Sandstone, limestone and other types of brittle rocks exist at a bottom of the aquifuge in a well field and have rigid lithology and strong compressive strength, so that a water-blocking compressive effect is very important. The different positions of the brittle rocks in the aquifuge cause the different water-blocking compressive effects. The brittle rock is able to play a key role only when being distributed in the effective aquifuge. If the brittle rock is distributed in the zone destroyed by underground mining, after the coal seam is mined, rupture cracks are produced in the brittle rock due to existence of the zone destroyed by underground mining. As a result, the water-blocking effect is not able to be realized. In a mining area range of the research area, the thickness of the brittle rock below the zone destroyed by underground mining is 0-56.35 m and mainly comprises coarse sandstones, fine sandstones and siltstones. According to the borehole data, statistical accumulation of the thickness data of the several types of the brittle rock is performed. Interpolation quantification processing is adopted. A contour map of the thickness of the brittle rock below the zone destroyed by underground mining is generated. And, a thickness thematic map of the brittle rock below the zone destroyed by underground mining is finally obtained (as shown in FIG. 4).

5) The distribution of the faults and the folds

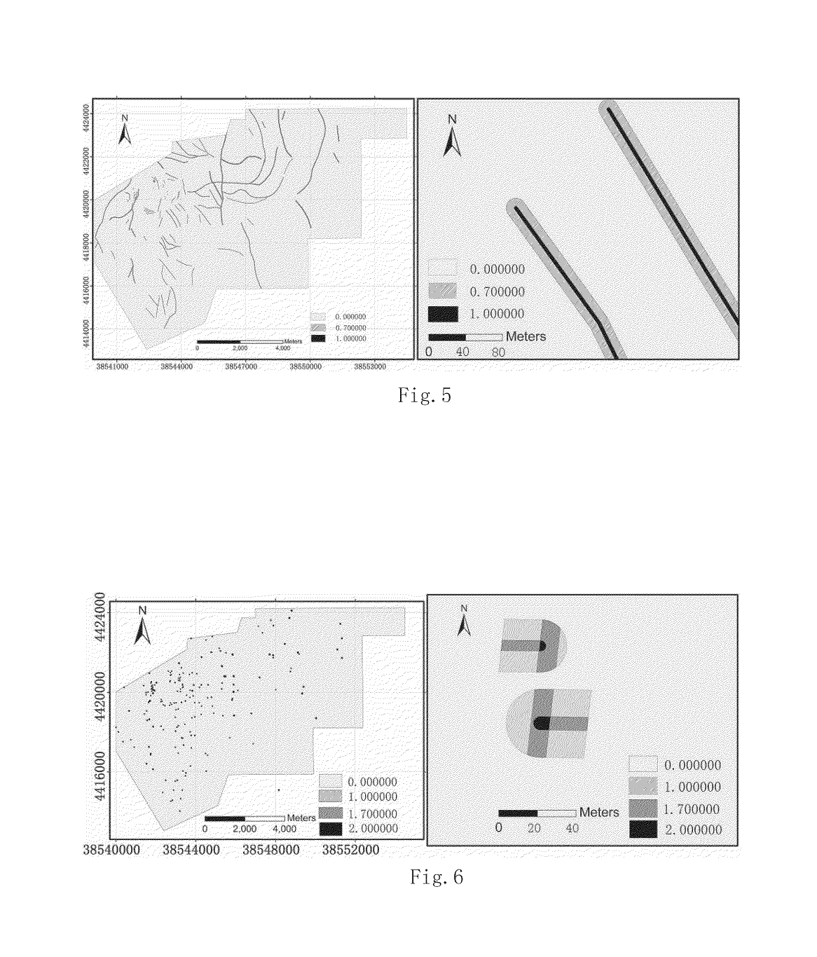

Structural faces of the faults and the cracks are weak faces protruding from the underlying coal seam. More than 80% of large-scale water inrush accidents are related to the faults and the cracks. The structural zones destroy integrity of rock mass and prone to become water guide channels. The existence of the faults and other structural zones further shorten a distance between the coal seam and the aquifer and increase possibility of the underlying water inrush. In addition, axial faces of the folds also enable the rock mass to rupture due to extrusion so as to greatly reduce the water-blocking effect. Therefore, we consider not only the faults, but also influence of axial parts of the folds when making structure distribution. As for the faults, we divide them into fracture zones of the faults and influencing zones of the faults (also referred to as buffer areas of the faults); and as for the folds, we only consider the influence of synclined and anticlined axial parts in a certain range of width. A thematic map of the distribution of the faults and the folds of the coal mine in the research area is formed according to hydrogeological map data of the research area and collection of measurements on fine investigation reports, as well as the faults and syncline and anticline data, which are reasonably speculated (as shown in FIG. 5).

6) The distribution of the intersection points and the endpoints of the faults and the folds

The faults and the folds are distributed and intersected on a space and a plane to have pinch outs and intersection points with a certain development law. The water guide possibility is enhanced at intersections of the faults, the endpoints of the faults and the folds and the endpoints of the folds. A thematic map of the intersection points and the endpoints of the faults and the folds are formed according to the data of the influencing zones of the faults in the influence range (as shown in FIG. 6).

7) The fault scale indexes

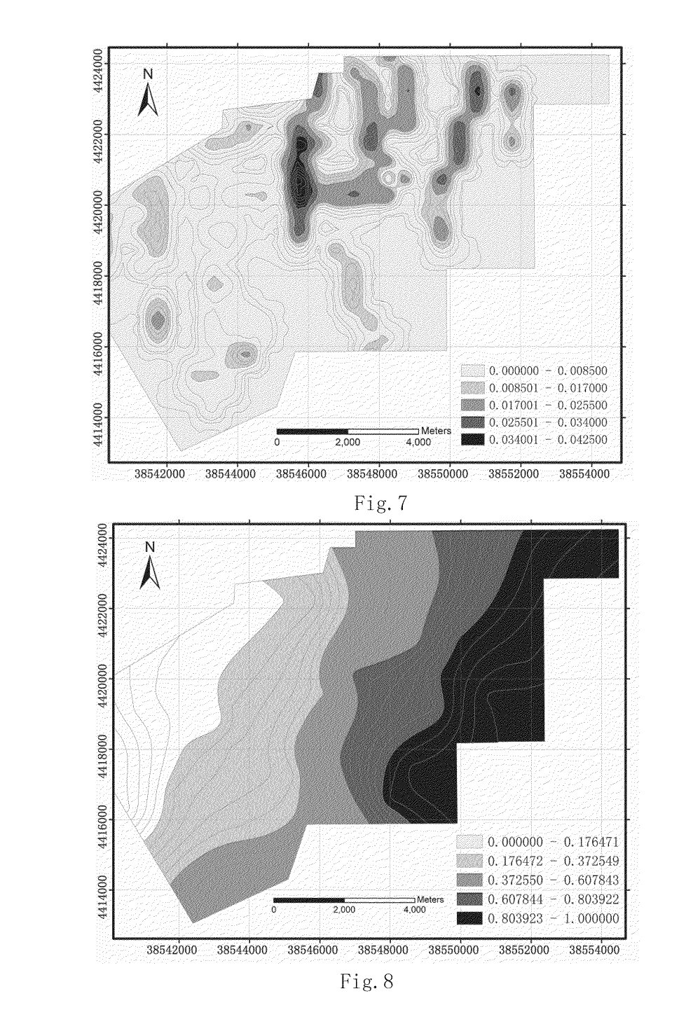

The fault scale index is able to comprehensively reflect a scale and a development extent of the fault and is another index influencing the vulnerability of the water inrush from the aquifer underlying coal seam. The larger fault scale index indicates the larger fault scale, the better development extent and the larger possibility of the water inrush. When a thematic map of the fault scale indexes is established, unit grids are firstly established according to a size of 250×250 m, statistics of a drop heights and a corresponding strike lengths of all the faults in the unit grids are gathered. The fault scale indexes are calculated by dividing a product of the drop heights and the strike lengths by 1000. Coordinates of central points of the grids are extracted and assigned with values, and a contour thematic map of the fault scale indexes is further drawn (as shown in FIG. 7).

According to the analysis of the geological data, a data quantity of the distribution of the karst collapse columns and the equivalent thickness of the Ordovician limestone top ancient weathering crust in the assessment area is very limited, indicating that the corresponding geological characteristics are not obvious and are notable to constitute the main control factors.

c) Normalizing and establishing data of a single-factor normalized thematic map.

In order to eliminate the influence of data of different dimensions of the main control factors on the assessment result, the normalization processing needs to be performed on the data, and the normalization purpose is to relativize, enable the data to have comparability and statistical significance and facilitate the system analysis.

$${A}_{i} = a + \frac{( b - a ) \times ( {x}_{i} - min ( {x}_{i} ) )}{max ( {x}_{i} ) - min ( {x}_{i} )} \qquad ( 3 \text{-} 4 )$$

In the formula 3-4, Aᵢ is the data after normalization processing, a and b are a lower limit and an upper limit of a normalization range respectively, 0 and 1 are taken in the research, and min(xᵢ) and max(xᵢ) are a minimum value and a maximum value of quantified values of each main control factor.

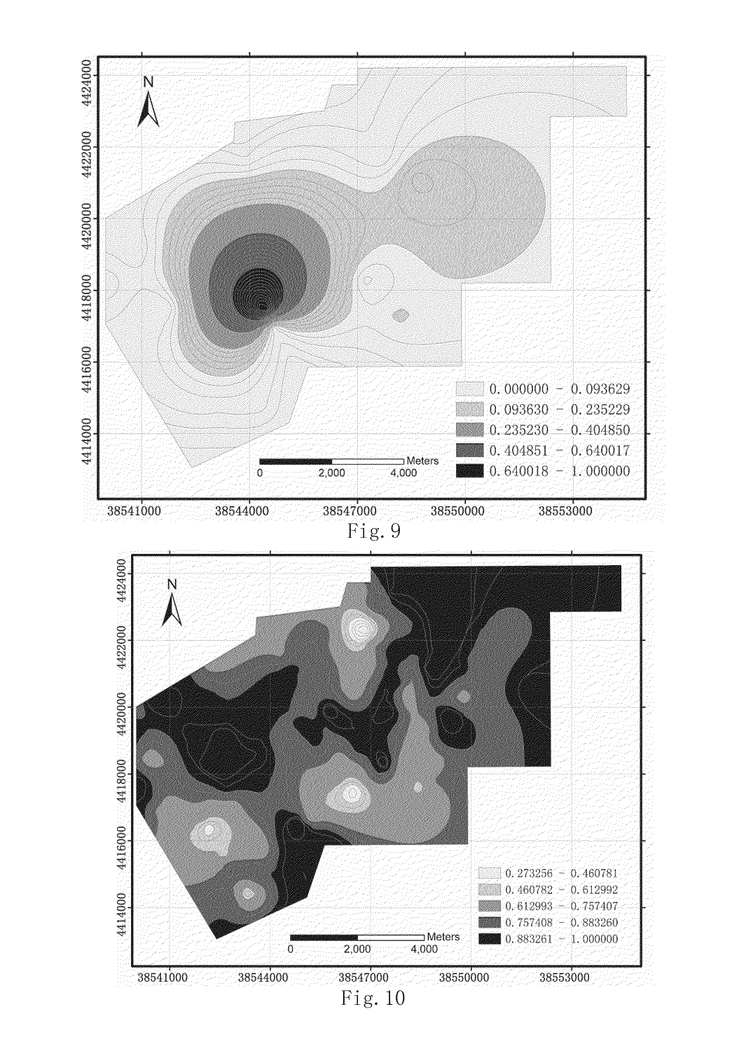

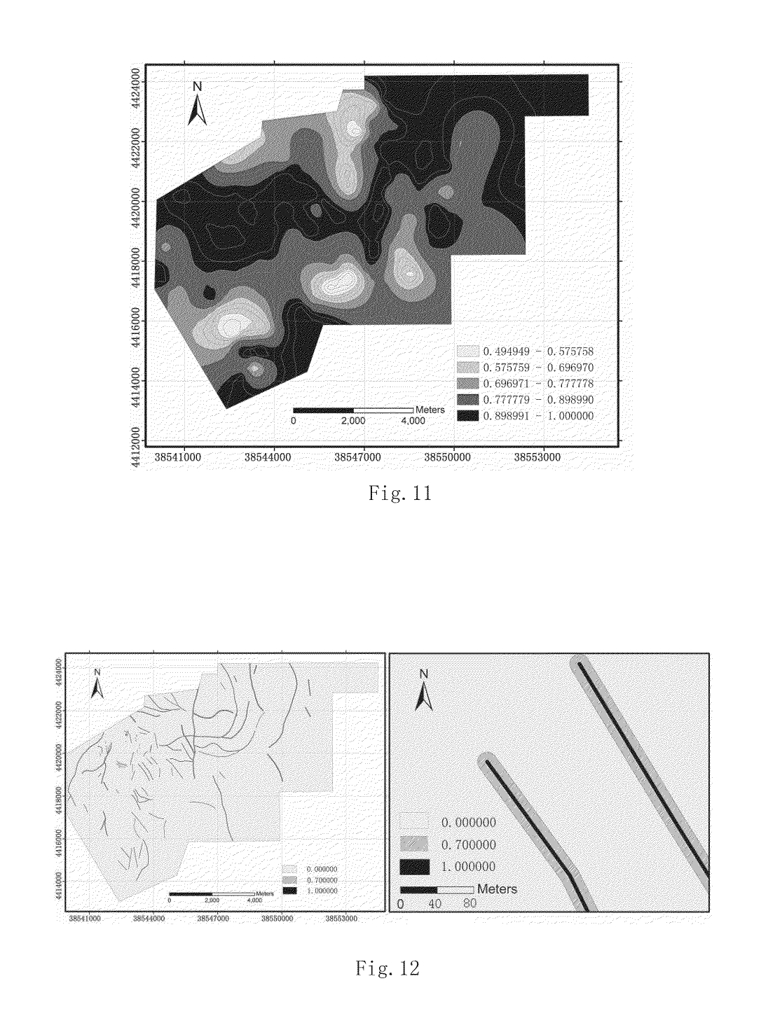

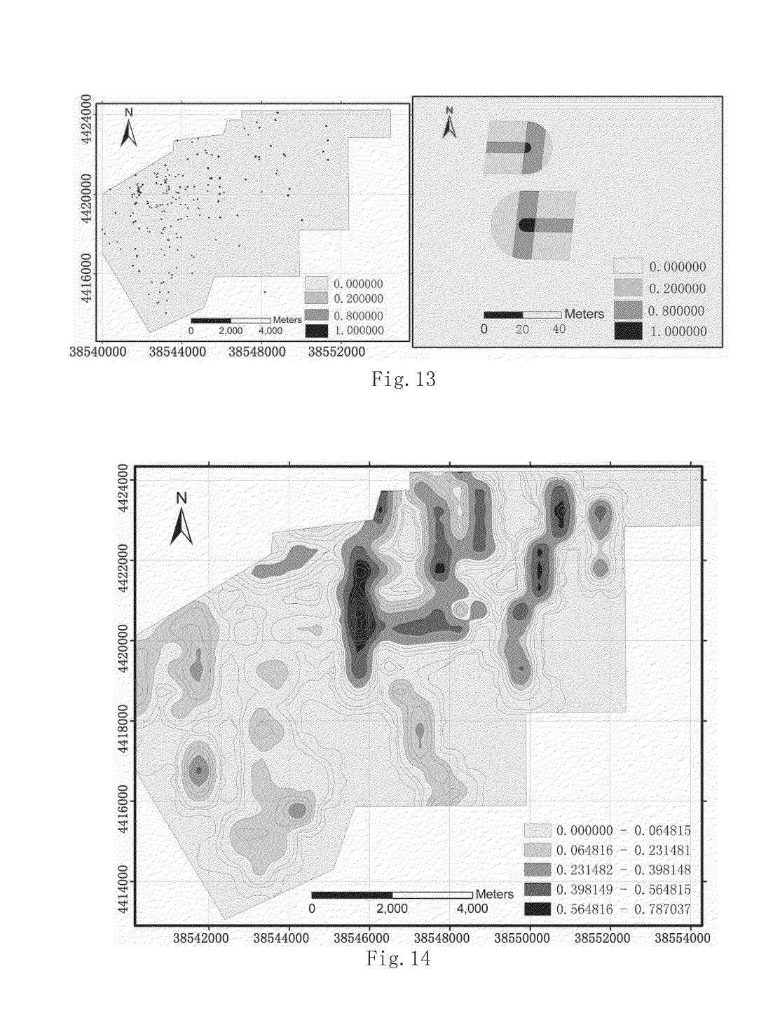

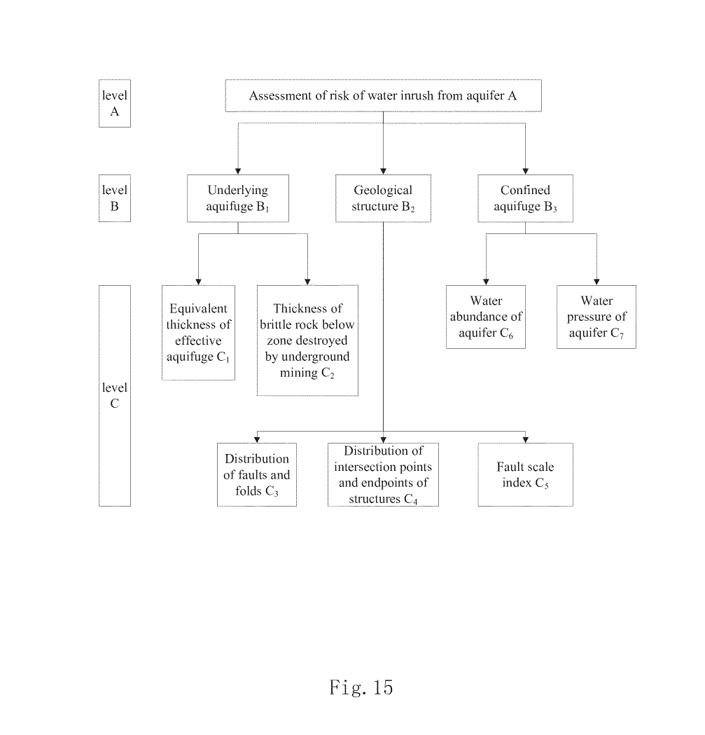

An attribute database of each single factor is able to be established after the normalization processing of the single factor data. A normalized thematic map of the respective single main control factors is obtained by applying GIS to process the normalized data (as shown in FIGS. 8-14).

d) Establishing the attribute databases.

Attribute data of the main control factors (quantified values) are input into a computer to generate the attribute databases by utilizing a management function of the GIS against spatial data, and correlation relation between graphic elements and the attribute databases is further established. The thematic maps of the respective main control factors and the respective attribute databases are based on the underlying vulnerability assessment to facilitate composite superimposition of the respective thematic maps of the main control factors, as well as statistics and inquiry of the data.

e) Determining constant weights of the main control factors by analytic hierarchy process (AHP).

1) Establishment of a Hierarchy Analysis Model

As shown in FIG. 15, a vulnerability assessment model of the water inrush from the underlying limestone aquifer of the coal seam divides research objects into three levels according to the analysis of the main control factors influencing the water inrush from the underlying limestone aquifer of the coal seam. Vulnerability assessment of the water inrush from the underlying limestone is a final purpose of the problem and is taken as a target layer of the model (level A); the confined aquifer, the geological structure and the underlying aquifuge determine the possibility of the water inrush, but the influencing ways still need to be represented by specific factors which are related to them, these form an intermediate link for solving the problem, namely a criterion layer of the model (level B); and indexes of the various specific main control factors constitute a decision-making layer (level C), and a target to be resolved is finally achieved by making a decision against the problem at this level.

2) Construction of Judgment Matrix

According to the analysis of the main control factors influencing the water inrush from the underlying limestone of the coal seam of the coal mine, by applying a method of “collecting evaluation scores of experts”, collecting and consulting suggestions of field experts and researchers in universalities and scientific research institutions, widely listening to their opinions and views, and referring to their personal experience in field production practices and scientific research and specific methods for processing the problems, score evaluation is performed on the main control factors influencing the water inrush. A scoring standard is in accordance with a 1-9 scale method created by T. L. SAATY, which comprises specific steps of: listing proposed factors influencing the water inrush in a table, asking the experts in the field to analyze the respective main control factors, then evaluate relative importance of each factor and give out a quantified value of each factor, finally comparing total scores of the respective factors according to the accumulated scores to form a judgment set of the experts against the respective influencing factors and further constructing a judgment matrix for the AHP assessment of the water inrush from the aquifer underlying coal seam.

3) Hierarchical Sorting and Consistency Testing

A single sorting weight at each level is determined according to the judgment matrix, as shown in Tables 1-4.

TABLE 1
Judgment Matrix A-Bᵢ (i = 1-3)

| A | B₁ | B₂ | B₃ | W(A/B) |
|---|---|---|---|---|
| B₁ | 1 | 1 | 1 | 0.3274 |
| B₂ | 1 | 1 | 1/2 | 0.2600 |
| B₃ | 1 | 2 | 1 | 0.4126 |

λ ₘₐₓ = 3,
CI₁ = 0.02681,
CR₁ = 0.04623 < 0.1

TABLE 2
Judgment Matrix B₁-Cᵢ (i = 5-6)

| B₁ | C₁ | C₂ | W(B₁/Cᵢ) |
|---|---|---|---|
| C₁ | 1 | 3 | 0.75 |
| C₂ | 1/3 | 1 | 0.25 |

λₘₐₓ = 2,
CI₂₁ = 0 and
CR₂₁ does not exist

TABLE 3
Judgment Matrix B₂-Cᵢ (i = 2-4)

| B₂ | C₃ | C₄ | C₅ | W(B₂/Cᵢ) |
|---|---|---|---|---|
| C₃ | 1 | 3 | 4 | 0.6337 |
| C₄ | 1/3 | 1 | 1 | 0.1919 |
| C₅ | 1/4 | 1 | 1 | 0.1744 |

λ ₘₐₓ = 3,
CI₂₂ = 0.00915,
CR₂₂ = 0.01577 < 0.1

TABLE 4
Judgment Matrix B₃-Cᵢ (i = 5-6)

| B₃ | C₅ | C₆ | W(B₃/Cᵢ) |
|---|---|---|---|
| C₆ | 1 | 1/2 | 0.3333 |
| C₇ | 2 | 1 | 0.6667 |

λₘₐₓ = 2,
CI₂₃ = 0,
CR₂₃ = 0 < 0.1

As presented in the tables, the values of λmax, CI and CR are calculated according to the groups of the matrices, the existing CRs are less than 0.1, and the judgment matrixes have satisfactory consistency and are able to pass a consistency test.

The weight of each index Ci to the total target is shown in Table 5, namely a weighing result of each index Ci to the target layer A via the layer Bi, the symbol A/Ci represents each index Ci relative to the total target A, and WA/Ci represents the weight of each index Ci to the total target A (Table 6).

A total sorting random consistency ratio of the layer C is able to be obtained by:

$${CR}_{2} = {CR}_{1} + \frac{{CI}_{2}}{{RI}_{2}} = {CR}_{1} + \frac{{\sum }_{i = 1}^{3} {CI}_{2 i} {W}^{A / {B}_{i}}}{{\sum }_{i = 1}^{3} {RI}_{2 i} {W}^{A / {B}_{i}}} = 0.00793 < 0.10 \qquad ( 3 \text{-} 5 )$$

When the satisfactory consistency is obtained, the WA/Ci is taken as a final decision-making basis, as shown in Table 5.

TABLE 5
Weight of Each Index to Total Target

| A/Cᵢ | B₁/0.3274 | B₂/0.260 | B₃/0.413 | W(A/Cᵢ) |
|---|---|---|---|---|
| C₁ | 0.75 | — | — | 0.24555 |
| C₂ | 0.25 | — | — | 0.08185 |
| C₃ | — | 0.6337 | — | 0.16477 |
| C₄ | — | 0.1919 | — | 0.04989 |
| C₅ | — | 0.1744 | — | 0.04534 |
| C₆ | — | — | 0.3333 | 0.13752 |
| C₇ | | | 0.6667 | 0.27508 |

Thus, the weight values of the 7 main control factors influencing the water inrush from the underlying limestone of the coal seam are determined, as shown in FIG. 6.

TABLE 6
Weight of Each Main Control Factor Influencing Water Inrush from Underlying Limestone of Coal Seam

| | | | | Distribution of | | | |
|---|---|---|---|---|---|---|---|
| | Equivalent | Thickness | Distribution | Intersection Points | Fault | Water | Water |
| | Thickness | of Brittle | of Faults | and Endpoints | Scale | Abundance | Pressure |
| Influencing | of Aquifuge | Rock | and Folds | of Faults | Index | of Aquifer | of Aquifer |
| Factor | (W₁) | (W₂) | (W₃) | (W₄) | (W₅) | (W₆) | (W₇) |
| Weight Wᵢ | 0.24555 | 0.08185 | 0.16477 | 0.04989 | 0.04534 | 0.13752 | 0.27508 |

f) Determining Variable Weight of Each Main Control Factor Based on a Zonation Variable Weight Model

1) Variable Weight Intervals and Parameter Thresholds of the Main Control Factors

(1) Determination of Thresholds of the Variable Weight Intervals

In combination with existing mine hydrogeological background data and on a basis of the measured data, system dynamic clustering analysis is adopted to gradually agglomerate and classify the respective factor index values, and the relative zonation is performed on each main control factor according to similarity of the index values, so that a spatial distribution state and the zonation characteristics of the respective main control factors are known and the variable weight intervals are determined according to the relative zonation results.

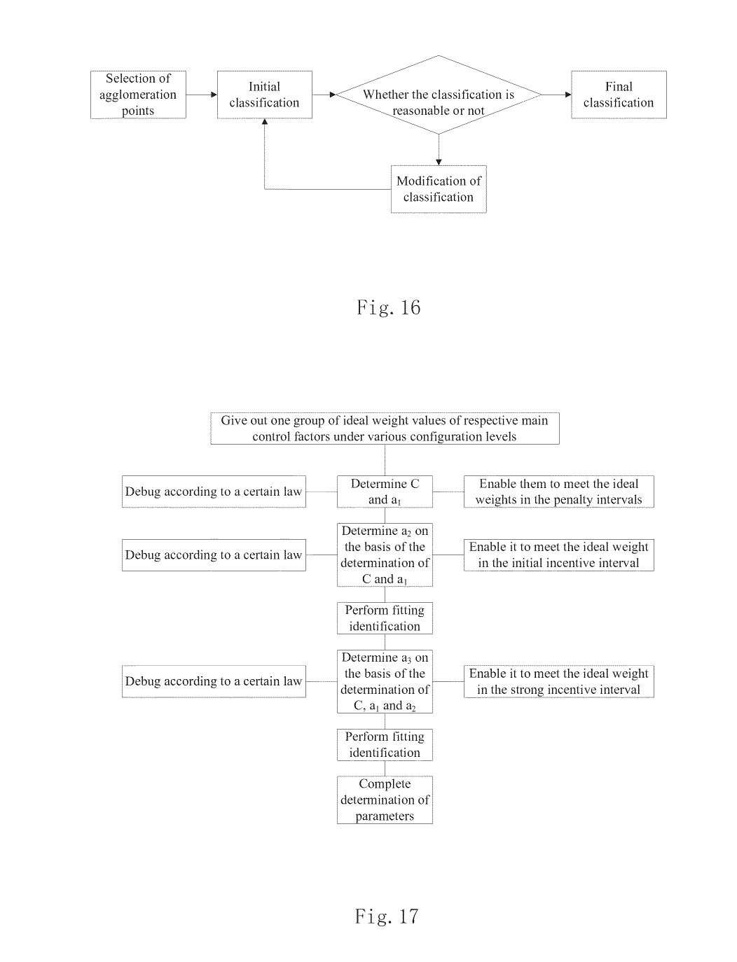

As shown in FIG. 16, the different dynamic clustering methods mainly perform zonation according to different principles of modification and classification, namely rough pre-classification is firstly performed and then the gradual adjustment is performed until satisfaction.

In the specific clustering analysis method, we select a K-means clustering method from the dynamic clustering methods and the data processing is simultaneously performed in combination with SPSS software. According to the K-means clustering method, we are able to determine classification critical values when the control factors are divided into four categories from the SPSS software. The control factors include the water pressure of the aquifer, the water abundance of the aquifer, the thickness of the brittle rock below the zone destroyed by underground mining, the equivalent thickness of the underlying effective aquifuge of the coal seam, and the fault scale indexes. For the two main control factors of the distribution of the faults and the distribution of the endpoints and the intersection points of the faults, the scale indexes are fixed, and the indexes values of the distribution of the faults after normalization are 0.7 and 1. The index values of the endpoints and the intersection points of the faults after normalization are 0.5, 0.7, 0.85 and 1. The thresholds of the variable weight intervals of the two factors are determined according to a principle of performing initial incentive processing on the influencing zones of the faults and the endpoints of the faults and performing strong incentive processing on the fracture zones of the faults and the intersection points of the faults and in combination with existing application experience, and the variable weight intervals of the corresponding respective main control factors are finally obtained, as shown in FIG. 7.

TABLE 7
Variable Weight Intervals of Respective Main Control Factors

| | Nature of Variable Weight Interval | | | |
|---|---|---|---|---|
| | | | Initial | Strong |
| | Penalty | No-incentive and | Incentive | Incentive |
| Main control factor | Interval | No-penalty Interval | Interval | Interval |
| Water Pressure of Aquifer | 0.2328 ≧ x ≧ 0 | 0.4656 ≧ x > 0.2328 | 0.7768 ≧ x > 0.4656 | x > 0.7768 |
| Equivalent Thickness of Aquifuge | 0.6341 ≧ x ≧ 0 | 0.8170 ≧ x > 0.6341 | 0.8902 ≧ x > 0.8170 | x > 0.8902 |
| Thickness of Brittle Rock Below Zone | 0.7111 ≧ x ≧ 0 | 0.8555 ≧ x > 0.7111 | 0.9133 ≧ x > 0.8555 | x > 0.9133 |
| Destroyed By Underground Mining | | | | |
| Water Abundance of Aquifer (L/(s · m)) | 0.0123 ≧ x ≧ 0 | 0.0264 ≧ x > 0.0123 | 0.2804 ≧ x > 0.0264 | x > 0.2804 |
| Distribution of Faults and Folds | | 0.5 ≧ x ≧ 0 | 0.8 ≧ x > 0.5 | x > 0.8 |
| Distribution of Intersection Points | | 0.35 ≧ x ≧ 0 | 0.5 ≧ x > 0.35 | x > 0.5 |
| and Endpoints of Faults | | | | |
| Fault Scale Index | 0.0648 ≧ x ≧ 0 | 0.231 ≧ x > 0.0648 | 0.509 ≧ x > 0.231 | x > 0.509 |

(2) Determination of Parameters to be Determined and a Regulation Level in State Variable Weight Vectors

As shown in FIG. 17, in a determination process of the zonation state variable weight vectors, in addition to determination of a form of a formula and the thresholds of the variable weight intervals (namely d₁, d₂ and d₃), a method for determining the regulation level C and the parameters a₁, a₂ and a₃ to be determined in the state variable weight vectors still needs to be determined. Through analysis and calculation, the parameters in this assessment are determined as follows: C=0.2, a₁=0.15, a₂=0.15 and a₃=0.3.

2) Establishment of the Zonation Variable Weight Model and Determination of the Variable Weights

The zonation variable weight model which is in line with the assessment law of the water inrush from the underlying coal seam is established on the basis of determination of the state variable weight vectors, and a specific formula is as follows:

$$\begin{matrix}W ( X ) {=}^{Δ} \frac{{W}_{0} • S ( X )}{{\sum }_{j = 1}^{m} {w}_{j}^{( 0 )} {S}_{j} ( X )} {=}^{Δ} ( \frac{{w}_{1}^{( 0 )} {S}_{1} ( X )}{{\sum }_{j = 1}^{m} {w}_{j}^{( 0 )} {S}_{j} ( X )} , \frac{{w}_{2}^{0} {S}_{2} ( X )}{{\sum }_{j = 1}^{m} {w}_{j}^{0} {S}_{j} ( X )} , … , \frac{{w}_{m}^{0} {S}_{m} ( X )}{{\sum }_{j = 1}^{m} {w}_{j}^{0} {S}_{j} ( X )} ) & ( 3 \text{-} 6 ) \\ wherein & \\ {S}_{j} ( x ) = \{ \begin{matrix}{e}^{{a}_{1} ( {d}_{1} - x )} + c - 1 , & x ∈ [ 0 , {d}_{1} ) \\ c , & x ∈ [ {d}_{1} , {d}_{2} ) \\ {e}^{{a}_{2} ( x - {d}_{2} )} + c - 1 , & x ∈ [ {d}_{2} , {d}_{3} ) \\ {e}^{{a}_{3} ( x - {d}_{3} )} + {e}^{{a}_{2} ( {d}_{3} - {d}_{2} )} + c - 2 , & x ∈ [ {d}_{3} , 1 ]\end{matrix} & ( 3 \text{-} 7 )\end{matrix}$$

S(X): an m-dimensional zone state variable weight vector; W₀=(w₁⁽⁰⁾, w₂⁽⁰⁾, . . . , wₘ⁽⁰⁾): any constant weight vector; W(X): an m-dimensional zone state variable weight vector; c: the regulation level; a1, a2 and a3: the parameters to be determined; and d1, d2 and d3: thresholds of variable weight intervals.

In combination with the formulas 3-7, the zonation variable weight model of the main control factors of the underlying water inrush of the 5# coal seam is established according to the formulas 3-6. Then the zonation variable weight model is utilized to resolve the variable weight of each main control factor, and the weight of each main control factor, which changes along with the changes in the state value of the factor is obtained on a basis of considering a configuration level of the state value of each factor, as shown in FIG. 8.

TABLE 8
Variable Weight Values of Respective Main Control Factors

| I | II | III | IV | V | VI | VII | VIII | IX | X | XI | XII | XIII | XIV |
|---|---|---|---|---|---|---|---|---|---|---|---|---|---|
| 0.3684 | 0.2794 | 0.5833 | 0.2473 | 0.9 | 0.1277 | 0.337 | 0.0931 | 0 | 0.1487 | 0 | 0.0451 | 0 | 0.0588 |
| 0.6316 | 0.341 | 0.25 | 0.2388 | 0.9 | 0.1133 | 0.345 | 0.0826 | 0 | 0.132 | 0 | 0.04 | 0 | 0.0522 |
| 0.7895 | 0.3992 | 0.1667 | 0.2375 | 0.9 | 0.098 | 0.3517 | 0.0715 | 0 | 0.1142 | 0 | 0.0346 | 0 | 0.0451 |
| 0.8947 | 0.4336 | 0 | 0.264 | 0.8 | 0.0697 | 0.388 | 0.0627 | 0 | 0.1001 | 0 | 0.0303 | 0 | 0.0396 |
| 0.9474 | 0.4697 | 0.0833 | 0.2324 | 0.8 | 0.0686 | 0.388 | 0.0618 | 0 | 0.0987 | 0 | 0.0299 | 0 | 0.039 |
| 0.8947 | 0.4461 | 0.0833 | 0.2427 | 0.8 | 0.0717 | 0.3826 | 0.0645 | 0 | 0.103 | 0 | 0.0312 | 0 | 0.0407 |
| 0.9474 | 0.457 | 0 | 0.2531 | 0.8 | 0.0668 | 0.3826 | 0.0601 | 0 | 0.096 | 0 | 0.0291 | 0 | 0.038 |
| 0.9474 | 0.457 | 0 | 0.2531 | 0.8 | 0.0668 | 0.3948 | 0.0601 | 0 | 0.096 | 0 | 0.0291 | 0 | 0.038 |
| 0.1579 | 0.2982 | 0.6667 | 0.2913 | 0.4 | 0.06 | 0.2982 | 0.0944 | 0 | 0.1508 | 0 | 0.0457 | 0 | 0.0596 |
| 0.1053 | 0.3188 | 0.6667 | 0.2828 | 0.3 | 0.0582 | 0.2851 | 0.0916 | 0 | 0.1464 | 0 | 0.0444 | 0 | 0.0579 |
| 0.2105 | 0.2823 | 0.6667 | 0.2903 | 0.6 | 0.0781 | 0.2851 | 0.0941 | 0 | 0.1503 | 0 | 0.0455 | 0 | 0.0594 |
| 0.2632 | 0.1856 | 0.9167 | 0.3134 | 0.8 | 0.0687 | 0.1464 | 0.0669 | 1 | 0.2422 | 0.85 | 0.084 | 0 | 0.0391 |
| 0.2632 | 0.2191 | 0.8333 | 0.3059 | 0.8 | 0.0811 | 0.1113 | 0.0842 | 0.7 | 0.1643 | 0.85 | 0.0992 | 0 | 0.0461 |
| 0.2632 | 0.1993 | 0.8333 | 0.2782 | 0.8 | 0.0738 | 0.2226 | 0.0664 | 1 | 0.2601 | 0.85 | 0.0902 | 0.1667 | 0.032 |
| 0.3158 | 0.2359 | 0.75 | 0.2768 | 0.8 | 0.0873 | 0.2317 | 0.0786 | 0.7 | 0.1768 | 0.85 | 0.1068 | 0.1667 | 0.0378 |
| 0.2632 | 0.2249 | 0.5 | 0.1905 | 0.5 | 0.0525 | 0.2274 | 0.0749 | 1 | 0.2935 | 1 | 0.1276 | 0.1667 | 0.0361 |
| 0.2632 | 0.2249 | 0.5 | 0.1905 | 0.5 | 0.0525 | 0.2274 | 0.0749 | 1 | 0.2935 | 1 | 0.1276 | 0.1667 | 0.0361 |
| 0.2632 | 0.2726 | 0.5 | 0.2309 | 0.5 | 0.0636 | 0.2274 | 0.0908 | 0.7 | 0.2043 | 0.7 | 0.094 | 0.1667 | 0.0437 |
| 0.2632 | 0.1852 | 0.9167 | 0.3127 | 0.8 | 0.0686 | 0.1288 | 0.069 | 1 | 0.2417 | 0.85 | 0.0839 | 0 | 0.039 |
| 0.2632 | 0.2241 | 0.8333 | 0.3128 | 0.8 | 0.083 | 0.2226 | 0.0747 | 0.7 | 0.168 | 0.85 | 0.1015 | 0.1667 | 0.036 |
| 0.2632 | 0.2216 | 0.8333 | 0.3094 | 0.8 | 0.0821 | 0.2226 | 0.0738 | 0.7 | 0.1661 | 0.85 | 0.1003 | 0 | 0.0467 |
| 0.3158 | 0.2359 | 0.75 | 0.2768 | 0.8 | 0.0873 | 0.2317 | 0.0786 | 0.7 | 0.1768 | 0.85 | 0.1068 | 0.1667 | 0.0378 |
| 0.3158 | 0.2526 | 0.6667 | 0.2597 | 0.8 | 0.0935 | 0.0307 | 0.1109 | 0.7 | 0.1893 | 0 | 0.0407 | 0 | 0.0532 |
| 0.3158 | 0.252 | 0.6667 | 0.2591 | 0.8 | 0.0933 | 0.0175 | 0.113 | 0.7 | 0.1889 | 0 | 0.0406 | 0 | 0.0531 |
| 0.3158 | 0.2614 | 0.5833 | 0.2314 | 0.8 | 0.0968 | 0.0175 | 0.1172 | 0.7 | 0.196 | 0 | 0.0422 | 0 | 0.055 |
| 0.3158 | 0.2614 | 0.5833 | 0.2314 | 0.8 | 0.0968 | 0.0175 | 0.1172 | 0.7 | 0.196 | 0 | 0.0422 | 0 | 0.055 |
| 0.3158 | 0.2283 | 0.5833 | 0.2021 | 0.8 | 0.0845 | 0.0175 | 0.1023 | 1 | 0.2979 | 0 | 0.0368 | 0 | 0.0481 |
| 0.3158 | 0.2211 | 0.6667 | 0.2273 | 0.8 | 0.0819 | 0.0175 | 0.0991 | 1 | 0.2885 | 0 | 0.0357 | 0 | 0.0465 |
| 0.3158 | 0.2606 | 0.5833 | 0.2307 | 0.8 | 0.0965 | 0 | 0.12 | 0.7 | 0.1953 | 0 | 0.042 | 0 | 0.0549 |
| 0.3158 | 0.2277 | 0.5833 | 0.2015 | 0.8 | 0.0843 | 0 | 0.1048 | 1 | 0.2971 | 0 | 0.0367 | 0 | 0.0479 |
| 0.2632 | 0.1962 | 0.9167 | 0.3313 | 0.8 | 0.0727 | 0.1464 | 0.0708 | 1 | 0.2561 | 0 | 0.0317 | 0 | 0.0413 |
| 0.2632 | 0.2375 | 0.8333 | 0.3316 | 0.8 | 0.088 | 0.1288 | 0.0884 | 0.7 | 0.1781 | 0 | 0.0383 | 0.1667 | 0.0381 |
| 0.1053 | 0.2375 | 0.75 | 0.2404 | 0.3 | 0.0434 | 0.5263 | 0.0755 | 1 | 0.2673 | 0.85 | 0.0928 | 0 | 0.0431 |
| 0.1053 | 0.2375 | 0.75 | 0.2404 | 0.3 | 0.0434 | 0.5263 | 0.0755 | 1 | 0.2673 | 0.85 | 0.0928 | 0 | 0.0431 |
| 0.3158 | 0.2353 | 0.6667 | 0.2419 | 0.8 | 0.0871 | 0.0307 | 0.1033 | 0.7 | 0.1763 | 0.85 | 0.1065 | 0 | 0.0495 |
| 0.3158 | 0.2429 | 0.5833 | 0.2151 | 0.8 | 0.0899 | 0.0175 | 0.1089 | 0.7 | 0.1821 | 0.85 | 0.11 | 0 | 0.0511 |
| 0.3158 | 0.214 | 0.5833 | 0.1895 | 0.8 | 0.0793 | 0.0175 | 0.0959 | 1 | 0.2793 | 0.85 | 0.0969 | 0 | 0.0451 |
| 0.3158 | 0.2077 | 0.6667 | 0.2136 | 0.8 | 0.0769 | 0.0175 | 0.0931 | 1 | 0.271 | 0.85 | 0.094 | 0 | 0.0437 |
| 0.2632 | 0.2065 | 0.9167 | 0.3485 | 0.8 | 0.0764 | 0.1288 | 0.0769 | 0.7 | 0.1548 | 0.85 | 0.0935 | 0 | 0.0435 |
| 0.2632 | 0.2191 | 0.8333 | 0.3059 | 0.8 | 0.0811 | 0.1113 | 0.0842 | 0.7 | 0.1643 | 0.85 | 0.0992 | 0 | 0.0461 |
| 0.2632 | 0.2241 | 0.8333 | 0.3128 | 0.8 | 0.083 | 0.2226 | 0.0747 | 0.7 | 0.168 | 0.85 | 0.1015 | 0.1667 | 0.036 |
| 0.2632 | 0.1993 | 0.8333 | 0.2782 | 0.8 | 0.0738 | 0.2226 | 0.0664 | 1 | 0.2601 | 0.85 | 0.0902 | 0.1667 | 0.032 |
| 0.2632 | 0.2216 | 0.8333 | 0.3094 | 0.8 | 0.0821 | 0.2226 | 0.0738 | 0.7 | 0.1661 | 0.85 | 0.1003 | 0 | 0.0467 |
| 0.2632 | 0.1973 | 0.8333 | 0.2755 | 0.8 | 0.0731 | 0.2226 | 0.0658 | 1 | 0.2575 | 0.85 | 0.0893 | 0 | 0.0415 |
| 0.3158 | 0.2359 | 0.75 | 0.2768 | 0.8 | 0.0873 | 0.2317 | 0.0786 | 0.7 | 0.1768 | 0.85 | 0.1068 | 0.1667 | 0.0378 |
| 0.3158 | 0.2085 | 0.75 | 0.2448 | 0.8 | 0.0772 | 0.2317 | 0.0695 | 1 | 0.2721 | 0.85 | 0.0944 | 0.1667 | 0.0335 |
| 0.1579 | 0.2392 | 0.5833 | 0.2012 | 0.4 | 0.0481 | 0.193 | 0.0757 | 1 | 0.2965 | 0.85 | 0.1029 | 0.1667 | 0.0365 |

Note:
Because the data quantity is large, only part of data is selected herein, wherein I-Water Pressure of Aquifer, II-Variable Weight, III-Equivalent Thickness of Effective Aquifuge, IV-Variable Weight, V-Thickness of Brittle Rock Below Zone Destroyed by Underground Mining, VI-Variable Weight, VII-Water Abundance of Underlying Limestone Aquifer, VIII-Variable Weight, IX-Distribution of Faults and Folds, X-Variable Weight, XI-Distribution of Intersection Points and Endpoints of Faults and Folds, XII-Variable Weight, XIII-Fault Scale Index, XIV-Variable Weight.

g) Applying Superimposition Process on the Thematic Maps.

Composite superimposition of the normalized thematic maps after eliminating the dimensions of the respective single factors is performed to form a new composite map by registration synthesis. A topological relation attribute table of the relevant data in the attribute databases is newly built. The composition of information storage layers of the various relevant factors is performed to form an information storage layer so as to perform multi-factor fitting analysis.

h) Establishing a Vulnerability Assessment Model of the Underlying Water Inrush Based on the Zonation Variable Weight Model

Actually, the establishment of the vulnerability assessment model of the water inrush from the aquifer underlying coal seam is establishment of a mathematical model showing effects of the various influencing factors, and calculated values according to the model are able to reflect a degree of risk of the water inrush from the aquifer underlying coal seam at a certain geographical position. Establishment of an initial model must be based on analysis of geological conditions, analysis of water inrush factors and contribution mechanisms of the respective factors against the water inrush.

For this reason, a VI (Vulnerability Index) initial model is introduced to assess the vulnerability of the water inrush from the aquifer underlying coal seam. The vulnerability index defines a sum of superimposed influence of the various influencing factors against the water inrush at a certain grid position in a certain section of a certain area.

The variable weight of each main control factor is determined according to the zonation variable weight model on the basis of the analysis of the geological conditions, the analysis of water inrush factor data and the contribution mechanisms of the respective factors against the water inrush. The vulnerability assessment model of the water inrush from the aquifer underlying coal seam in the investigation area is established, which is represented by a following model formula (3-8):

$$VI = {\sum }_{i = 1}^{m} {w}_{i} • {f}_{i} ( x , y ) = {\sum }_{i = 1}^{m} \frac{{w}_{i}^{( 0 )} {S}_{i} ( X )}{{\sum }_{j = 1}^{m} {w}_{j}^{( 0 )} {S}_{j} ( X )} {f}_{i} ( x , y ) = \frac{{w}_{1}^{( 0 )} {S}_{1} ( X )}{{\sum }_{j = 1}^{7} {w}_{j}^{( 0 )} {S}_{j} ( X )} {f}_{1} ( x , y ) + \frac{{w}_{2}^{( 0 )} {S}_{2} ( X )}{{\sum }_{j = 1}^{7} {w}_{j}^{( 0 )} {S}_{j} ( X )} {f}_{2} ( x , y ) + \frac{{w}_{3}^{( 0 )} {S}_{3} ( X )}{{\sum }_{j = 1}^{7} {w}_{j}^{( 0 )} {S}_{j} ( X )} {f}_{3} ( x , y ) + \frac{{w}_{3}^{( 0 )} {S}_{3} ( X )}{{\sum }_{j = 1}^{7} {w}_{j}^{( 0 )} {S}_{j} ( X )} {f}_{3} ( x , y ) + \frac{{w}_{4}^{( 0 )} {S}_{4} ( X )}{{\sum }_{j = 1}^{7} {w}_{j}^{( 0 )} {S}_{j} ( X )} {f}_{4} ( x , y ) + \frac{{w}_{5}^{( 0 )} {S}_{5} ( X )}{{\sum }_{j = 1}^{7} {w}_{j}^{( 0 )} {S}_{j} ( X )} {f}_{5} ( x , y ) + \frac{{w}_{6}^{( 0 )} {S}_{6} ( X )}{{\sum }_{j = 1}^{7} {w}_{j}^{( 0 )} {S}_{j} ( X )} {f}_{6} ( x , y ) + \frac{{w}_{7}^{( 0 )} {S}_{7} ( X )}{{\sum }_{j = 1}^{7} {w}_{j}^{( 0 )} {S}_{j} ( X )} {f}_{7} ( x , y ) \qquad ( 3 \text{-} 8 )$$

VI: vulnerability index; Wᵢ: variable weight vector of influencing factor; and f₁(x,y): function of single factor-influencing value;

(x,y): geographic coordinates; w⁽⁰⁾: any constant weight vector; and S(X): m-dimensional zone state variable weight vector.

i) Vulnerability assessing zonation of the water inrush from the aquifer underlying coal seam based on the zonation variable weight model.

According to the formula 3-8, the vulnerability index (VI) of the Ordovician limestone water inrush of each superimposition unit in the assessment area is calculated. The larger vulnerability index indicates the stronger vulnerability and the relatively larger risk of the underlying water inrush; while the smaller vulnerability index indicates the smaller vulnerability and the relatively smaller risk of the underlying water inrush. Then, a commonly used Natural Breaks (Jenks) method on a hierarchical map is applied to grading of the vulnerability index (VI) values, then a five-level grading result is obtained, and intermediate data of the assessment zonation of the vulnerability index method of the water inrush from the underlying Ordovician limestone of the 5# coal seam and a corresponding Ordovician limestone water inrush thematic map are finally formed.

Vulnerability index grading thresholds of the water inrush from the underlying confined Ordovician limestone aquifer of the 5# coal seam are 0.591137, 0.506855, 0.427520 and 0.344868 respectively. The larger the vulnerability index is, the larger the possibility of the water inrush will be. The research area is divided into five areas according to the grading thresholds:

VI>0.591137 Water inrush most vulnerable area

0.506855<VI≦0.591137 Water inrush vulnerable area

0.427520<VI≦0.506855 Water inrush transition area

0.344868<VI≦0.427520 Water inrush probably safety area

VI≦0.344868 Water inrush relative safety area

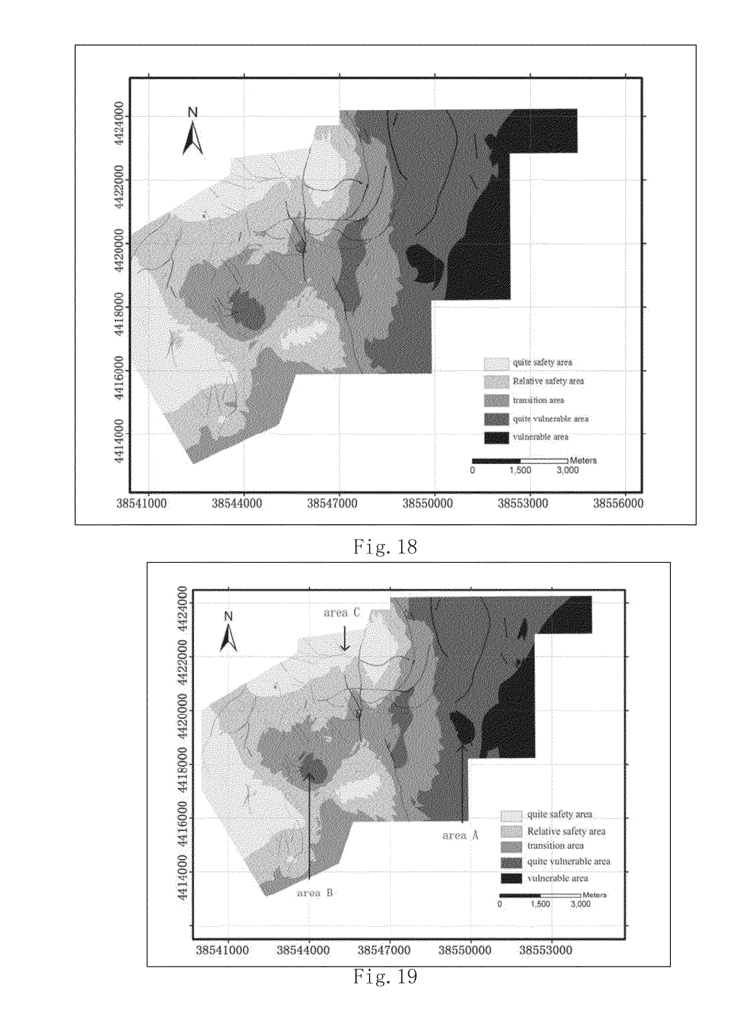

As shown in FIG. 18, the vulnerability zonation is performed against the vulnerability of the water inrush from the underlying limestone of the 5# coal seam in the assessment area according to the zonation thresholds by utilizing the intermediate data and the corresponding Ordovician limestone water inrush thematic map, and a vulnerability assessment prediction map of the underlying water inrush based on a zonation variable weight principle is finally obtained.

j) Providing Accuracy Comparative Analysis of a Variable Weight Assessment Effect and a Conventional Constant Weight Assessment Effect.

The comparative analysis of the vulnerability assessment result obtained by using the zonation variable weight model and the vulnerability assessment result obtained by the conventional method using the AHP is further performed by utilizing the water inrush vulnerability assessment zonation map through the intuitive form of the thematic maps, and the variable weight assessment result and the advancement of conventional assessment are analyzed.

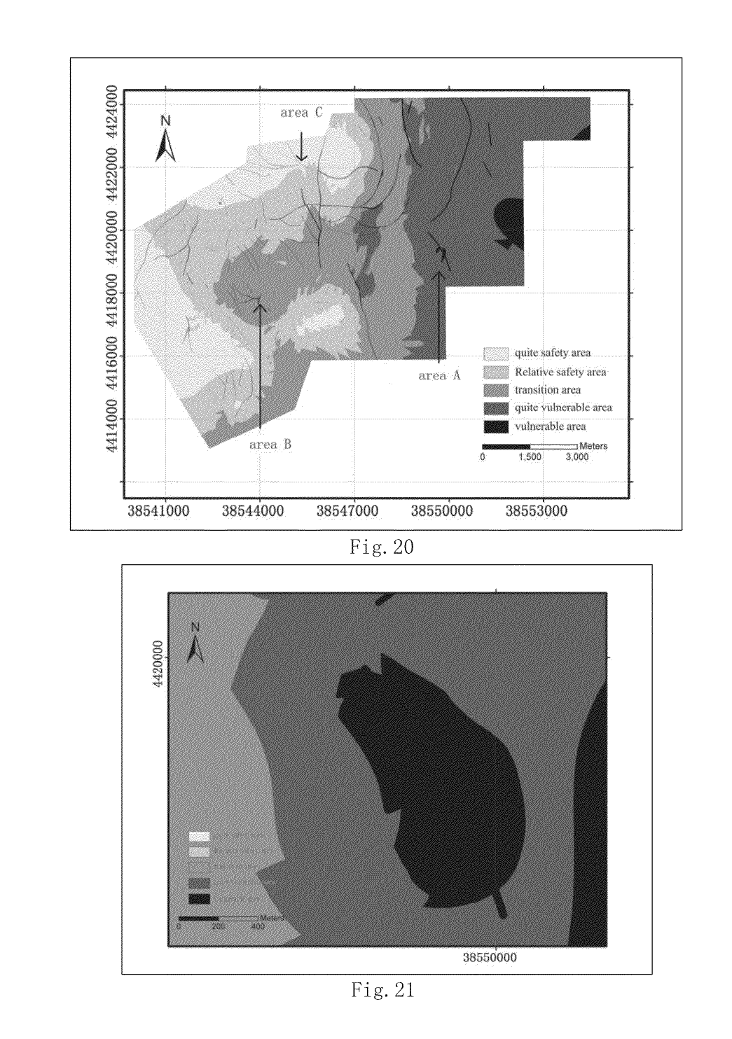

By comparing the assessment results of the variable weight and the conventional constant weight models (see FIGS. 19 and 20), on the whole, general trends of the two are consistent, namely the vulnerability of the underlying water inrush from east to west is gradually enhanced, and the risk of the water inrush is gradually increased. It is able to be obviously seen that, there are differences in partial areas and differences in partial typical blocks are enlarged for fine comparative analysis as follows:

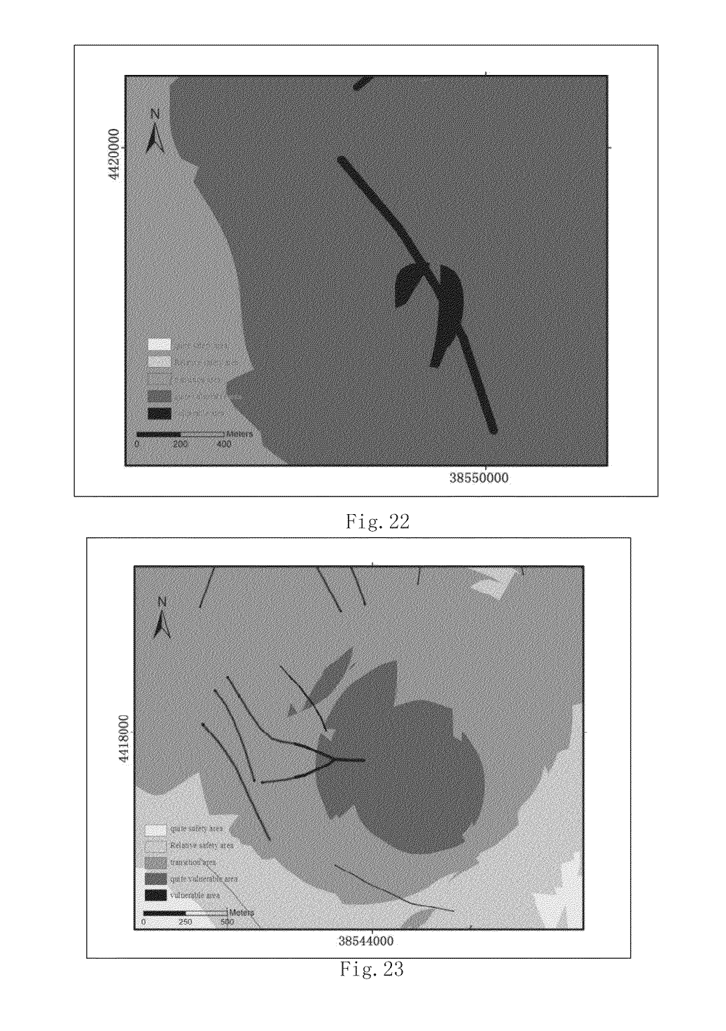

It is able to be seen from partial enlarged views of the area A of FIG. 21 and FIG. 22 (see FIGS. 19 and 20) that, the assessment result of a central position of the area based on the variable weight model is a vulnerable area, and the assessment result of most of the area at a corresponding position based on the constant weight model is a quite vulnerable area. The main reason causing the difference is that the equivalent thickness of the effective aquifuge in the area is very thin. The equivalent thickness of the effective aquifuge in a red area at the central position in FIG. 12 is only 2.5 m, and the thickness is far smaller than that of a surrounding area. The conventional constant weight model cannot reflect a sudden change situation that the thickness of the effective aquifuge in the area is very thin by adjusting the weights, while the variable weight model is able to reflect the sudden change situation that the equivalent thickness of the effective aquifuge in the area is very thin in the form of weighted weights, and the assessment results are more accurate in comparison with the conventional constant weight model.

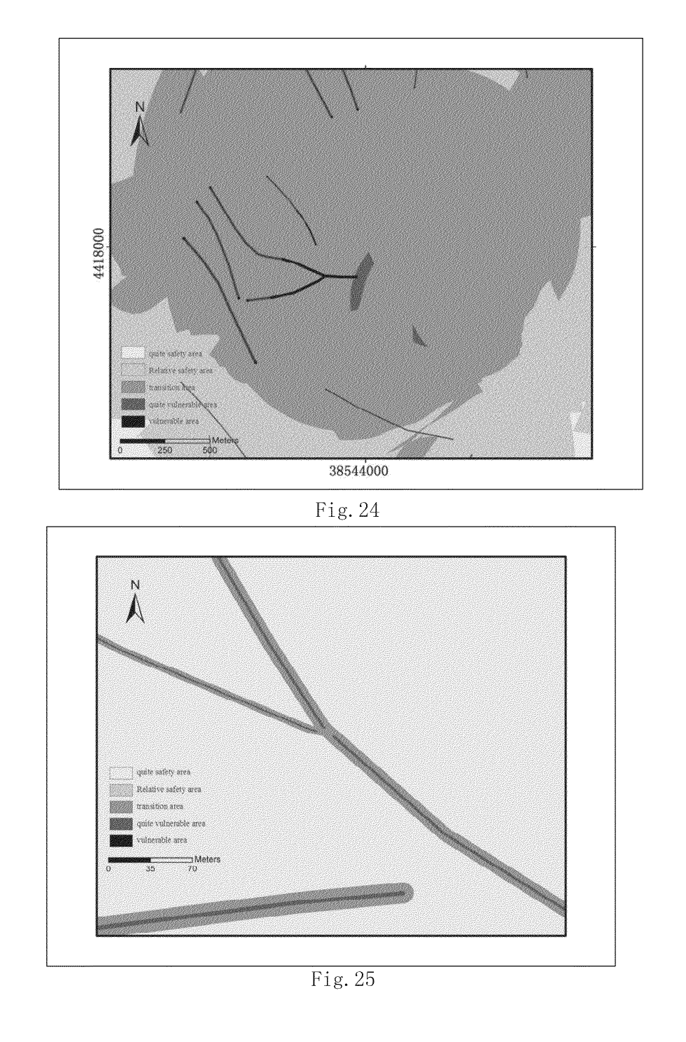

As shown in partial enlarged views of the area B of FIG. 23 and FIG. 24 (see FIGS. 19 and 20) that, a central position based on the variable weight model is a quite vulnerable area, and most of the area at a corresponding position based on the constant weight model is a transition area. The reason causing the difference is that the water abundance of the aquifer in the area is greater than that of a surrounding area. The unit water inflow value is about 3.86 L/s·m, which is far stronger than the water abundance of the surrounding area. Therefore, compared with other main control factors of the underlying water inrush, the weight value of the influence of the water abundance of the aquifer in the area should be reinforced. Under the variable weight model, the effect of the water abundance of the aquifer is highlighted in the area, and the assessment results are more accurate in comparison with the conventional constant weight model.

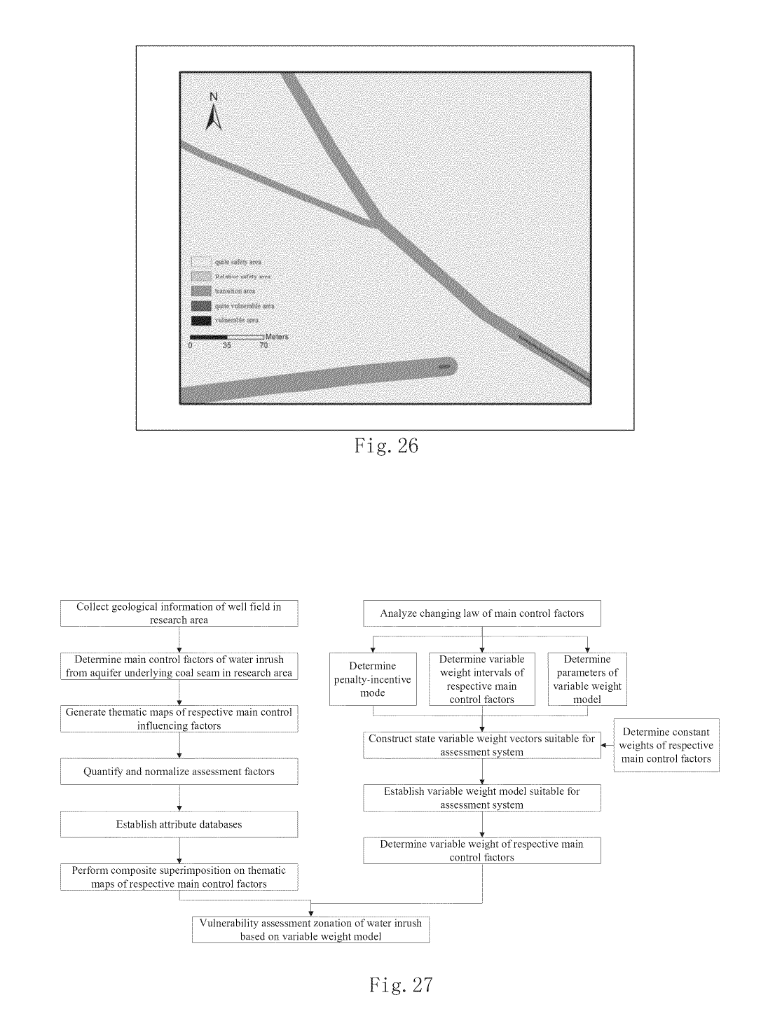

It is able to be seen from comparative analysis of FIG. 25 and FIG. 26 (see FIGS. 19 and 20), the assessment results of the rupture zones of the faults based on the variable weight model are the quite vulnerable areas, and the assessment results under the constant weight model are the transition areas. As the weights of fracture structures are fixed in the constant weight model, there are blocks with the fracture structures, and after multi-source information of the respective factors is superimposed, the vulnerability of the fractures is reduced and weakened, and an effect of absolutely controlling the underlying water inrush of the fracture structures cannot be highlighted. However, in the variable weight model, by reinforcing the weights of the fracture structures in a “punitive” manner, the effect of absolutely controlling the partial water inrush of the fracture structures is able to be better highlighted.

Through the above analysis, we are able to see that in the vulnerability assessment of the water inrush from the aquifer underlying coal seam, compared with the conventional constant weight model, the variable weight model is able to reflect the influence of the sudden changes of the index values of the respective main control factors on the assessment results in a more exact manner “Penalty” index values are factors with effects of promoting the underlying water inrush, and “reward” index values are factors with effects of hindering the underlying water inrush. As the above blocks A, B and C, the variable weight model is able to better depict the weight “penalties” of the factors in the situations that the thickness of the effective aquifuge becomes thin, the water abundance becomes strong, the distribution of the fracture structures and other index values have obvious sudden changes and describe a hydrogeological physical concept model of the underlying water inrush of the #5 coal seam in the mining area in Weizhou more realistically.

As shown in FIG. 27, based on the data processing process of the vulnerability assessment of the water inrush from the aquifer underlying coal seam, the abstract data collection, the data processing, the model establishment and the data assessment by using the model are able to be summarized into a simple system working process.

The above embodiments are merely used for describing the preferred implementation ways of the invention rather than limiting the scope of the invention; and on the premise of not departing from the design spirit of the invention, those skilled in the art can make various variations and improvements to the technical solution of the invention and all the variations and the improvements should fall within the protection scope defined by the claims.

### INDUSTRIAL APPLICABILITY

The vulnerability assessment of the water inrush from the aquifer underlying coal seam based on the zonation variable weight model has important influence on the production of the coal mine. Thus, the judgment of the underlying coal seam and the sustained analysis basis for assessment of the water inrush are more reliable. The major defects in the conventional assessment method are overcome. Specific pilot tests prove that the assessment precision of the assessment method is more in line with the actually sampled data. The assessment method is able to be popularized and used in a larger coal mining range, and the method has very strong industrial practicality and operability, as well as great significance in the aspects of reducing the loss of the mineral reserves, improving the production safety level and increasing the minable reserves.

What is claimed is:

1. A vulnerability assessment method of water inrush from an aquifer underlying coal seam based on a zonation variable weight model, comprising steps of:
step 1, collecting main control factors of underlying water inrush, which are determined by geological data of a target area to be assessed;
step 2, quantifying relevant data against the main control factors of the underlying water inrush to form thematic maps for each main control factor;
step 3, performing normalization processing against attribute data corresponding to the respective main control factor thematic maps to eliminate the influence of dimension factors among the attribute data and form normalized thematic maps corresponding to the respective main control factors;
step 4, establishing databases of normalized attribute data corresponding to the normalized thematic maps by utilizing GIS;
step 5, determining a constant weight of each main control factor based on a constant weight model;
step 6, determining a variable weight of each main control factor based on a zonation variable weight model;
step 7, performing composite superimposition on the normalized thematic maps of the respective single main control factors, and newly building a topological relation of the relevant data among the attribute databases for performing multi-factor fitting analysis; and
step 8, establishing an underlying water inrush vulnerability assessment model based on the zonation variable weight model to perform vulnerability assessment of the water inrush from the aquifer underlying coal seam.

2. The vulnerability assessment method of the water inrush from the aquifer underlying coal seam based on the zonation variable weight model according to claim 1, wherein the main control factors in the step 1 are obtained by collection and processing of basic data of a water-filled aquifer of the underlying coal seam, basic data of the geological structure of the coal seam and basic data of water-impermeable strength of an aquifuge.

3. The vulnerability assessment method of the water inrush from the aquifer underlying coal seam based on the zonation variable weight model according to claim 2, wherein the main control factors in the step 2 comprise a plurality of items in an equivalent thickness of an effective aquifuge, a thickness of brittle rock below a zone destroyed by underground mining, distribution of faults and folds, distribution of intersection points and endpoints of the faults and the folds, fault scale indexes, water abundance of an underlying limestone aquifer, water pressure of the underlying limestone aquifer, distribution of karst collapse columns, an equivalent thickness of an Ordovician limestone top ancient weathering crust according to geological conditions.

4. The vulnerability assessment method of the water inrush from the aquifer underlying coal seam based on the zonation variable weight model according to claim 3, wherein an normalization formula adopted for eliminating influence of data of different dimensions of the main control factors on an assessment result in the step 3 is as follows:
$${A}_{i} = a + \frac{( b - a ) \times ( {x}_{i} - min ( {x}_{i} ) )}{max ( {x}_{i} ) - min ( {x}_{i} )} \qquad ( 3 \text{-} 4 )$$
wherein Aᵢ is the data after normalization processing, a and b are a lower limit and an upper limit of a normalization range respectively, 0 and 1 are taken in this research, and min(xᵢ) and max(xᵢ) are a minimum value and a maximum value of quantified values of each main control factor.

5. The vulnerability assessment method of the water inrush from the aquifer underlying coal seam based on the zonation variable weight model according to claim 4, wherein a weight value of each control factor is determined by establishing a hierarchy analysis model, constructing a judgment matrix and performing hierarchical sorting and consistency testing.

6. The vulnerability assessment method of the water inrush from the aquifer underlying coal seam based on the zonation variable weight model according to claim 5, wherein the zonation variable weight model utilized for determining the variable weight of each main control factor in the step 6 is as follows:
$$\begin{matrix}W ( X ) {=}^{Δ} \frac{{W}_{0} • S ( X )}{{\sum }_{j = 1}^{m} {w}_{j}^{( 0 )} {S}_{j} ( X )} {=}^{Δ} ( \frac{{w}_{1}^{( 0 )} {S}_{1} ( X )}{{\sum }_{j = 1}^{m} {w}_{j}^{( 0 )} {S}_{j} ( X )} , \frac{{w}_{2}^{0} {S}_{2} ( X )}{{\sum }_{j = 1}^{m} {w}_{j}^{0} {S}_{j} ( X )} , … , \frac{{w}_{m}^{0} {S}_{m} ( X )}{{\sum }_{j = 1}^{m} {w}_{j}^{0} {S}_{j} ( X )} ) & ( 3 \text{-} 6 ) \\ wherein & \\ {S}_{j} ( x ) = \{ \begin{matrix}{e}^{{a}_{1} ( {d}_{1} - x )} + c - 1 , & x ∈ [ 0 , {d}_{1} ) \\ c , & x ∈ [ {d}_{1} , {d}_{2} ) \\ {e}^{{a}_{2} ( x - {d}_{2} )} + c - 1 , & x ∈ [ {d}_{2} , {d}_{3} ) \\ {e}^{{a}_{3} ( x - {d}_{3} )} + {e}^{{a}_{2} ( {d}_{3} - {d}_{2} )} + c - 2 , & x ∈ [ {d}_{3} , 1 ]\end{matrix} & ( 3 \text{-} 7 )\end{matrix}$$
S(X): an m-dimensional zone state variable weight vector; W₀=(w₁⁽⁰⁾, w₂⁽⁰⁾, . . . , wₘ⁽⁰⁾: any constant weight vector; W(X): an m-dimensional zone state variable weight vector; c: a regulation level; a1, a2 and a3: parameters to be determined; and d1, d2 and d3: thresholds of variable weight intervals.

7. The vulnerability assessment method of the water inrush from the aquifer underlying coal seam based on the zonation variable weight model according to claim 6, wherein a formula of the underlying water inrush vulnerability assessment model in the step 8 is represented as follows:
$$VI = {\sum }_{i = 1}^{m} {w}_{i} • {f}_{i} ( x , y ) = {\sum }_{i = 1}^{m} \frac{{w}_{i}^{( 0 )} {S}_{i} ( X )}{{\sum }_{j = 1}^{m} {w}_{j}^{( 0 )} {S}_{j} ( X )} {f}_{i} ( x , y ) = \frac{{w}_{1}^{( 0 )} {S}_{1} ( X )}{{\sum }_{j = 1}^{7} {w}_{j}^{( 0 )} {S}_{j} ( X )} {f}_{1} ( x , y ) + \frac{{w}_{2}^{( 0 )} {S}_{2} ( X )}{{\sum }_{j = 1}^{7} {w}_{j}^{( 0 )} {S}_{j} ( X )} {f}_{2} ( x , y ) + \frac{{w}_{3}^{( 0 )} {S}_{3} ( X )}{{\sum }_{j = 1}^{7} {w}_{j}^{( 0 )} {S}_{j} ( X )} {f}_{3} ( x , y ) + \frac{{w}_{3}^{( 0 )} {S}_{3} ( X )}{{\sum }_{j = 1}^{7} {w}_{j}^{( 0 )} {S}_{j} ( X )} {f}_{3} ( x , y ) + \frac{{w}_{4}^{( 0 )} {S}_{4} ( X )}{{\sum }_{j = 1}^{7} {w}_{j}^{( 0 )} {S}_{j} ( X )} {f}_{4} ( x , y ) + \frac{{w}_{5}^{( 0 )} {S}_{5} ( X )}{{\sum }_{j = 1}^{7} {w}_{j}^{( 0 )} {S}_{j} ( X )} {f}_{5} ( x , y ) + \frac{{w}_{6}^{( 0 )} {S}_{6} ( X )}{{\sum }_{j = 1}^{7} {w}_{j}^{( 0 )} {S}_{j} ( X )} {f}_{6} ( x , y ) + \frac{{w}_{7}^{( 0 )} {S}_{7} ( X )}{{\sum }_{j = 1}^{7} {w}_{j}^{( 0 )} {S}_{j} ( X )} {f}_{7} ( x , y ) \qquad ( 3 \text{-} 8 )$$
VI: a vulnerability index; Wᵢ: a variable weight vector of influencing factor; and fᵢ(x,y): a function of a single factor-influencing value;
(x,y): geographic coordinates; w⁽⁰⁾: any constant weight vector; and S(X): an m-dimensional zone state variable weight vector.

8. The vulnerability assessment method of the water inrush from the aquifer underlying coal seam based on the zonation variable weight model according to claim 7, wherein the thresholds of the variable weight intervals of the zonation variable weight model are determined by a dynamic clustering method.

9. The vulnerability assessment method of the water inrush from the aquifer underlying coal seam based on the zonation variable weight model according to claim 8, wherein values of the regulation level C in the state variable weight vector and the parameters a₁, a₂ and a₃ to be determined in the zonation variable weight model are as follows: C=0.2, a₁=0.15, a₂=0.15, and a₃=0.3.
